(19) United States
(12) Patent Application Publication
(10) Pub. No.: US 2011/0203123 A1
(43) Pub. Date: Aug. 25, 2011

(54) Ktc injury prevention chain saw

(76) Inventor: Lyndon Henry Holcomb, Port Lavaca, TX (US)

(21) Appl. No.: 12/799,414

(22) Filed: Apr. 22, 2010

Related U.S. Application Data
(63) Continuation-in-part of application No. 12/660,045, filed on Feb. 19, 2010.

(51) Int. Cl. B27B 17/02; B27G 19/00; B27B 17/00

(52) U.S. Cl. 30/382; 30/383; 30/520

(57) ABSTRACT

A chainsaw that increases the level of operator safety by reducing or eliminating cut through and kickback injuries without impeding cutting operations, and increases operator comfort through ergonomics, therefore extending stamina. This is accomplished by a dual stage multi-hinged bar device that physically inhibits kickback and cut through injuries. The device, which returns to it's original position after cutting, will open up a total of 88 degrees to allow for cutting of items that are larger than the length of the guide bar. Relocation of the handles leads users toward physically holding the saw in such a manner that creates an ergonomically advantageous body position, reducing fatigue and strains. The body of the saw and the bar device will rotate 45 and 90 degrees both right and left while the handles and operators grip remain in the same position. The chainsaw also incorporates an easy to use chain adjustment.

### RELATED APPLICATIONS

The present application is related to U.S. Pat. No. 5,666,733, issued Aug. 16, 1997, for GUIDEBAR FOR A MOTOR CHAINSAW, included by reference herein.

The present application is related to U.S. Pat. No. 4,294,012, issued Oct. 13, 1981, for CHAINSAW ANTI-PINCH GUARD ARM, included by reference herein.

The present application is related to U.S. Pat. No. 7,140,114 B2, issued Nov. 28, 2006, for GUARD FOR CHAINSAW, included by reference herein.

The present application is related to U.S. Pat. No. 5,237,752, issued Jul. 24, 1993, for MOVABLE CONTROL HANDLE FOR CHAINSAW, included by reference herein.

The present application is related to United States patent number US 2006/0248734 A1, issued Nov. 9, 2006, for CHAINSAW KICKBACK PROTECTION DEVICE, included by reference herein.

### FIELD OF THE INVENTION

The present invention relates to chainsaw operations and, more particularly, to reducing or eliminating kickback and cut through injuries now common to chainsaw operations.

### BACKGROUND OF THE INVENTION

Since the invention of the chainsaw, there have been continuous injuries resulting from the operation of them. The majority of serious injuries can be divided into two basic categories. “Cut Through” and “Kickback” injuries. “Cut Through” injuries occur when the operator cuts through the material he or she is cutting and into their own lower extremities, generally their left upper thigh or lower legs or feet. However, injuries caused by kickback are often even more horrific. “Kickback” injuries can occur at almost any time.

Chainsaws can kickback so suddenly and violently that chainsaw users cannot possibly control the saw when this happens as most kickback events generally occur within two tenths ( 2/10) of a second. When severe kickback does occur, the operator is either injured or is simply fortunate that an injury did not occur. Either way, the operator has little or no control over neither the event itself, nor the end results. However, there are two things that we can be sure of: 1) despite some operators best intentions to prevent kickback, kickback often occurs; and 2) when severe kickback does occur, it is often with frightening consequences, at times resulting in disfiguring or debilitating injuries and even fatalities.

Identifying the root cause of “Kickback” injuries:

“Kickback” occurs when the saw kicks back, and usually up, as a result of the saw blade coming in contact with an object while it is spinning, especially when the front of the saw blade strikes an object while the saw is running at or near full speed. Chainsaws can also kickback sideways if cutting sideways or down if using the top of the blade. As the “blade” is a chain, bristling with sharp teeth designed to cut the hardest wood, and traveling at speeds up to 68 mph, these injuries are often extremely serious. Kickback injuries can occur on almost any part of the body, because when severe kickback occurs the operator loses his grip, if not total control of the chainsaw.

The result is a fully operational chainsaw being thrown back toward the operator. The fact is that most users do not hold chainsaws in such a manner that would help inhibit kickback and cut through injuries even when instructed to do so immediately prior to use. In fact, there isn't really a safe way to handle a chainsaw which would effectively prevent those types of injuries, because the problem is due to poor ergonomic design of the saw itself. Even those operators whom start out by holding the saw with a sturdy grip, left arm straight with their elbow locked, soon gravitates away from this more desirable body position due to fatigue or because they must constantly change body position in order to make difficult, angled, hard to reach cuts.

Consequently, it is counterproductive to try to implement training which encourages chainsaw operators to consistently use a specific body position to prevent injuries, because that in itself could not possible prevent kickback and cut through injuries due to the operator having to constantly change positions with both the saw and his body. So better body positioning could not prevent injuries, due to the fact that chainsaws are designed so poorly with respect to ergonomics and operator safety. In fact, statistics show that chainsaws are the single most dangerous hand tool used by modern man. There are an estimated 40,000 chainsaw injuries each year. That equates to one chainsaw injury every 12 seconds or each workday. Clearly, attempting to training operators to hold the saw in a specific way has not resulted in a reduction of injuries.

One problem is that operators also tend to focus on cutting and forget that they are operating the most dangerous hand tool ever created, if they were ever aware of that fact in the first place. Another problem is that operators must hold chainsaws away from the body using mostly arm strength to control the saw, resulting in operators having limited control over the saw from the very beginning of cutting operations.

Identifying the Cause of “Cut Through” Injuries

Because the design of the saw itself dictates that the saw must be held at approximately a 45 degree left angle from the center of the operators body, cut through injuries are always a possibility, but at times when operators are fatigued they tend to angle the saw even further left and bring the back of the saw even closer to their body, the possibility of cut through injuries to the upper left thigh, and elsewhere on the lower extremities increases as chainsaw operators begin griping the saw less tightly and even further out of the already unnatural position that they must use to hold the saw, due to the poor design of the saw itself.

The main contributing factor to “Cut Through” injuries to the lower extremities is the positioning of the two handles that operators must hold onto when operating a chainsaw. The handle at the rear end of the chainsaw, where the speed control is located, is misplaced causing the operator to hold the rear of the saw out away from, and towards the right side of his body. The position of the bar handle at the left side of the saw is also part of the overall problem. When an operator grips the saw by the handles provided for him to do so, the chain naturally sets dangerously close to the left leg of the operator, and is the direct result of the poor positioning of the two handles.

This position becomes even more pronounced and hazardous when the operator becomes fatigued. It is at this time that the operator tends to bring the saw closer to the body which in turn angles the chainsaw even further left; i.e., the operator brings the right hand/rear handle of the saw toward the right side of the waist and brings the left hand closer to the body so as to relieve muscle strain the in arms, shoulder, and back. The longer the operator uses the saw, the more this is compounded because of the ever increasing fatigue of holding the saw out away from the body utilizing mostly arm strength. The fact is clear, the more fatigued an operator becomes, the closer he brings the saw to his body and shifts his weight by moving his left leg forward and his right leg back, resulting in the chain becoming even closer to his left leg. It is at this time that operators are most vulnerable, and the possibility of an injury escalates.

The Chain Brake

Low Kickback Chains

Guide bar nose protector

Protective bar over top of saw chain

The Chain Brake which is located in front of the front bar handle is only practical if you succumb to the notion that kickbacks are inevitable. The chain brake is located where it is so that when the saw kicks back and is hurled back toward the operator, his left hand may possibly disengage the chain as the saw flies by him. This is the current attitude because in cases of a kickback event, the event is usually over before it is even possible for the operator to physically react. (two tenths of a second)

Low Kickback Chains are designed to reduce kickback and therefore kickback injuries. While these chains do tend to reduce kickback forces, they do not eliminate them entirely, and kickback remains an ongoing and dangerous problem. Low kickback chains also reduce the cutting ability of the chain and therefore efficiency and productivity of the saw.

The Guide bar nose protector is an inadequate solution for preventing kickback. While it does prevent the end of the chain from contacting other objects, it's very design limits the ability of the saw to fully function. The result is that with the device in place cutting operations are generally limited to limbing and bucking operations of small limbs. Consequently, most operators eventually remove the device during chainsaw operations, and it soon becomes an afterthought, is lost or even thrown away.

There are several variations of a protective bar over top of saw chains. All are reactionary devices. The designers are resigned that kickback will occur, and when it does, it is hoped that the device will prevent injury by shielding the operator from the top of the chain when the saw kicks back onto the operator. The problem of kickback isn't addressed, only the result.

### SUMMARY OF THE INVENTION

In accordance with the present invention, there is provided a chainsaw that increases the level of operator safety by reducing or eliminating cut through and kickback injuries without impeding cutting operations, while increasing operator comfort through ergonomics and therefore extending the operators stamina and control of the chainsaw over prolonged cutting operations. This will be accomplished in part by placing a barrier bar under the chain in the form of a tri-stage spring actuated multi-hinged bar that serves to physically inhibit both kickback and cut through injuries, and relocation of the handles that serve to lead users toward physically holding chainsaws in such a manner during operation, that simply holding the chainsaw itself creates an ergonomically advantageous body position, which also helps prevent kickback and cut through injuries, as well as prevents the muscle fatigue and strains which cause operators to gravitate toward ever more dangerous body positions while operating chainsaws.

The body of the saw and the anti-kickback/cut through device will rotate 45 and 90 degrees both right and left while the handles and therefore the operators grip on the saw remains the same. The bar will have two rows of rear facing spikes that will work in conjunction with the first, second, and third stage springs on the device to hold the object being cut firmly between the device and the chain. When engaging an item to be cut, the first stage of the tri-stage multi-hinge bar will deploy first, followed by the second stage. When the first two stages are deployed, the device will open up a total of 88 degrees to allow for cutting of logs and trees that are larger in diameter than the length of the guide bar and chain. Both stages will have springs that will cause the device to close as the cut is being made, and at the completion of the cut the device will return to it's original position. The rear facing spikes on the bar will lay horizontally below the surface plane of the top of the anti-kickback/cut through device bar via the pushbutton spike control when the operator disengages from cutting a tree or log. This will allow the operator to remove the saw without interference from the rear facing spikes.

The second stage of the anti-kickback/cut through device will also have a cylinder which operates on ambient air and has a spring return piston. During normal cutting operations, the cylinder will simply open and close along with the second stage of the device as it is deployed and retracted. A flow control valve attached to the cylinder will seize the piston rod on the ambient air cylinder when the anti-kickback/cut through device is subject to the sudden force that is created during a kickback event. The instant stoppage of any upward movement of the saw by the cylinder, coupled with the log being held in place between the guide bar and the device bar by spring force and the rear facing spikes on the bar itself will stop any backward movement. The third stage of the bar opens in the opposite direction of the first two stages. The third stage of the anti-kickback/cut through device is a one direction spring loaded hinge located middle way between the forward end of the bar and the second stage hinge point that allows the end of the bar to bend upward. This allows the operator to keep the saw on a horizontal plane when cutting large logs on the ground.

The presence of the bar itself prevents any cut through injuries from occurring. Because the saw rotates while the handles stay in the same place, the kickback motion arrest capabilities of the bar device will be accomplished without regards to which direction the cut is being made. The chainsaw also incorporates a chain adjusting device that makes adjusting the chain extremely simple and easy. The guide bar is attached onto a plate via three studs. The plate slides into a corresponding track built onto the chainsaw. The plate itself moves forward and back via either a worm and pinion gear or a scissor gear that is turned by a knob to adjust tension on the chain. The saw has a gearbox that contains an oil environment operated centrifugal clutch and three mechanical gears. The gearbox protects the gears and the oil environment operated centrifugal clutch from corrosion, rust and debris. The gear arrangement serves to lower the guide bar and chain so that it sits 3/32 of an inch above the anti-kickback/cut through device bar. This in turn positions the anti-kickback/cut through device bar at a lower point, making it easier for the operator to slide the bar under logs on the ground.

It would be advantageous to provide a chainsaw which prevents kickback and cut through injuries.

It would also be advantageous to provide a chainsaw that creates an ergonomically advantageous body position that decreases operator fatigue and therefore extends stamina.

It would also be advantageous to provide a chainsaw that tilts both right and left while maintaining the handles in the same position.

It would also be advantageous to provide a chainsaw that allows for simple and easy chain adjustment.

It would further be advantageous to provide a chainsaw that does not impede normal operations while providing the above advantages.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a right view of a chainsaw with stage one, two, and three of the anti-kickback/cut through device retracted;

FIG. 2 is a right view of a chainsaw with stage one of the anti-kickback/cut through device deployed;

FIG. 3 is a right view of a chainsaw with stage one and two of the anti-kickback/cut through device deployed;

FIG. 4 is a right view of a chainsaw with stage one, two, and three of the anti-kickback/cut through device deployed;

FIG. 5 is a right perspective view of a chainsaw with stage on of the anti-kickback/cut through device deployed;

FIG. 6 is an exploded view of an anti-kickback/cut through device bar showing the internal components;

FIG. 7 is a right detail view of a froward and center sections of the anti-kickback/cut through device bar showing the rear facing spikes in the erect position;

FIG. 8 is a right detail view of a forward and center sections of the anti-kickback/cut through device bar showing the rear facing spikes in the retracted position;

FIG. 9 is an exploded view of an incremental rotational control, torso pad, and rear handle in relation to the saw body;

FIG. 10 is a right perspective view of a rear handle adjustable horizontal extension sections with throttle and pushbutton spike controls. the inside section of the rear handle is attached to the incremental rotational control;

FIG. 11 is a right perspective view of a bar handle in relation to the saw body;

FIG. 12 is a right perspective view of a chainsaw with the incremental rotational control adjusted 90 degrees to the right;

FIG. 13 is a right perspective view of a chainsaw with the incremental rotational control adjusted 45 degrees to the right;

FIG. 14 is a right perspective view of a chainsaw with the incremental rotational control adjusted 45 degrees to the left;

FIG. 15 is a right perspective view of a chainsaw with the incremental rotational control adjusted 90 degrees to the left;

FIG. 16 is an exploded view of a gearbox, gears, oil environment centrifugal clutch, chain tension adjustment mechanism, guide bar with chain, guide bar mounting plate, guide bar mounting plate adjustment slot, and the gearbox cover in relation to the saw body;

FIG. 17 is an exploded view of a gearbox, mechanical gear assembly, oil environment centrifugal clutch, chain tension adjustment mechanism, guide bar mounting plate, guide bar mounting plate adjustment slot, gearbox reservoir cover plate, gearbox oil fill plug, and the chain sprocket;

FIG. 18 is a right perspective view of a guide bar mounting plate, guide bar and chain, and nuts;

FIG. 19 is a right perspective view of a saw body, gearbox cover, and the bottom mold;

FIG. 20 is a right perspective view of a stage two compression springs, compression spring protector sleeves, bottom mold with the anti-kickback/cut through device with stage one deployed;

FIG. 21 is a right view of a bottom mold, anti-kickback/cut through device, telescoping backstop rod, forward facing spikes on the bottom mold, forward facing spikes on the anti-kickback/cut through device bar, stage two front hinge connector rods, rear facing spikes on the anti-kickback/cut through device bar, rear bar hinge, ambient air cylinder/flow control valve, ambient air cylinder/flow control valve cover, and ambient air cylinder/flow control valve cover screws;

FIG. 22 is a bottom view of a bottom mold with the forward facing spikes on the bottom mold, stage two front hinge connector rods, spiral wound torsion spring, spiral wound torsion spring cover, ambient air cylinder/flow control cover, and the rear section of the anti-kickback/cut through device bar hinge; and

FIG. 23 is an exploded view of the anti-kickback/cut through device bar, ambient air cylinder/flow control valve, and ambient air cylinder cover and screws.

For purposes of clarity and brevity, like elements and components will bear the same designations and numbering throughout the Figures.

### DESCRIPTION OF THE PREFERRED EMBODIMENT

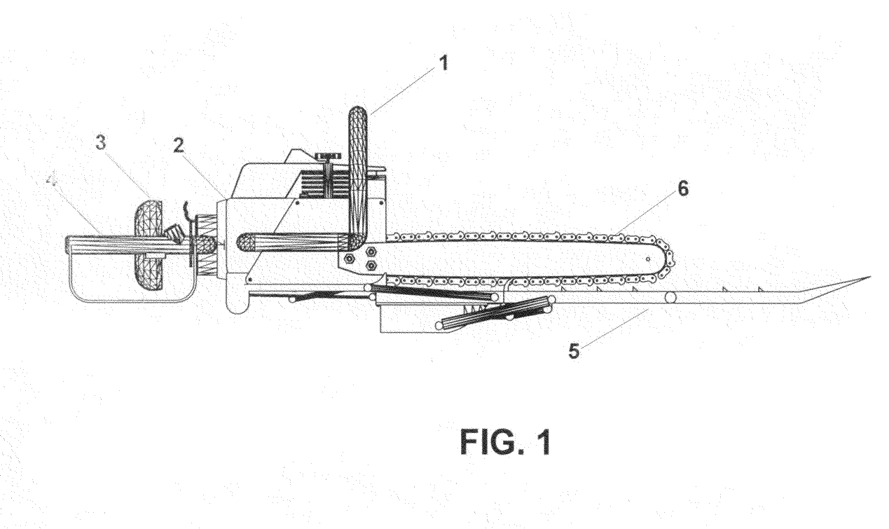

FIG. 1 is a right view of the chainsaw with stage one, two and three of the anti-kickback/'cut through device 5 in the closed position. The torso pad 3 is visible at the rear of the saw. The bar handle 1 has been redesigned so that it goes around the sides and top of the saw body 2 symmetrically in order to allow the operator to maintain grip at the same distance from the rear handle 4 when operating the saw with the incremental rotational control 16 set at an angle. This represents a significant part of an overall system that begins with repositioning and redesigning both handles in order to better maintain control of the saw, and help combat the fatigue and muscle strain that arises during continuous use of the chainsaw.

The rear handle 4 is repositioned and is attached to the right rear side of the saw, and the throttle control 21 is located on the rear handle 4. Also mounted on the top of the rear handle 4 is the pushbutton spike control 20 for releasing the rear facing spikes 8 on the anti-kickback/cut through device 5 when the operator is pulling the bar out from under a log on the ground or removing the saw in order to vacate the area when cutting a hinge in order to fell an upright tree.

The rear handle 4 is a two-piece telescoping adjustable aluminum tube that extends out horizontally past the operators right waist, then turns 90 degrees back and continues for approximately another five inches. There is a spring-pin adjustment mechanism 19 on the rear handle 4 that is able to be moved to several holes along the handle, making the handle horizontally adjustable to the waist size of each individual operator.

This places the rear handle 4 in a position where the operator can grip it without moving his arm very far from where it hangs naturally so that the operator can grip the saw without the saw swinging left, which is contributing factor of cut through injuries. This helps place an easier load between the shoulders, and balances the saw. When the operator holds the saw by the repositioned handles; it is positioned closer, and straight away forward from the center of the operator's body.

The handle realignment will help prevent cut through injuries, which generally occur to the left side of the lower extremities due to current chainsaw designs that puts the blade at approximately a forty-five degree angle from front center of the operators body. The weight redistribution resulting from the handle realignment will increase control, and help combat the fatigue and muscle strain that arises during continuous use of the chainsaw. The relocation of the handles also presents an opportunity to create an ergonomic body position in relation to the how the operator holds and uses the saw that will naturally inhibit kickback and cut through injuries.

The torso pad 3 is a small circular/convex pad, approximately six inches in diameter, aligned center to the saw, and located on the back of the saw body 2, where the rear handle 4 was previously located. Operators can brace the torso pad 3 and therefore the back of the saw against the torso at approximately the waist area whenever possible. The operator will not always be able to use the torso pad 3, but when used, it will stabilize the saw via the bracing action.

The torso pad 3 is spring mounted on a single pin aligned center of the saw which will allow the pad to rotate in a clockwise/counter clockwise motion. The torso pad pin spring mount 18 has approximately three inches of horizontal travel in order to counter vibration and any kickback motions of the saw against the torso. Positioning the saw at a lower axis for operation and bringing it closer to the body, will naturally straighten out both arms and lock the left elbow, which is one key in preventing kickback.

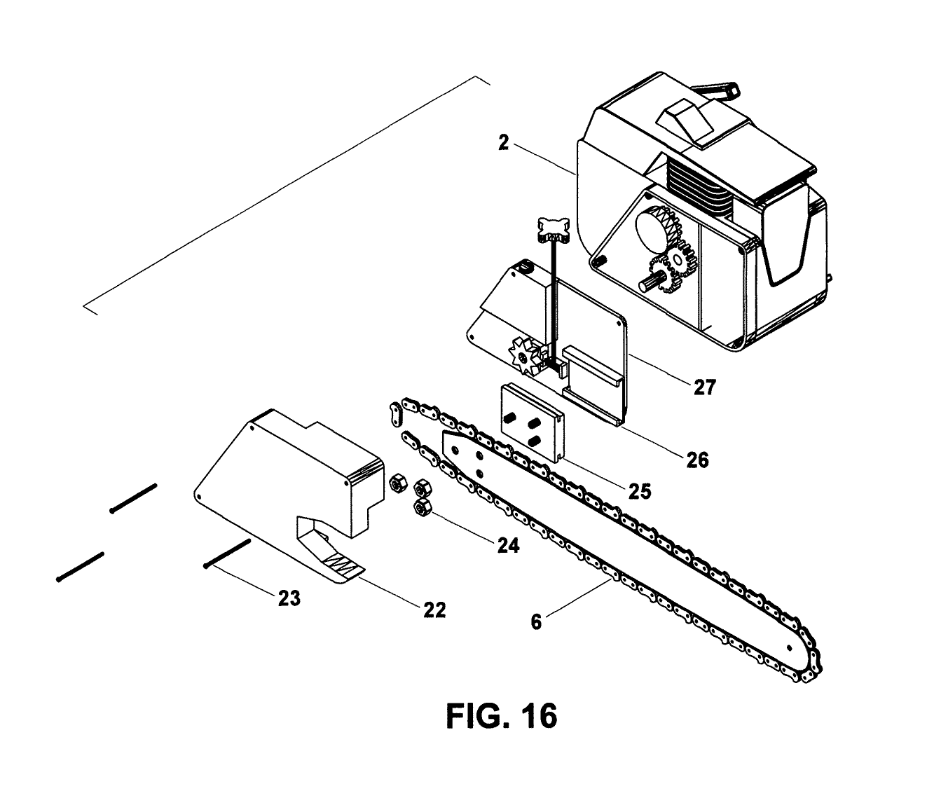

The guide bar 6 shown on FIG. 1 is shown mounted onto three studs that is attached to the guide bar mounting plate 25. This will be further expounded upon in the detailed description of FIGS. 16, 17 and 18.

On FIG. 1, the anti-kickback/cut through device 5 bar is shown closed. The anti-kickback/cut through device 5 is made of fiberglass. The fiberglass bar will help protect from accidental electrocution by its placement between possible electrical sources and the chain. The bar will be hollowed out in places to accommodate internal components and wherever possible to reduce overall weight. The anti-kickback/cut through device 5 is a multi-hinged tri-stage device.

The forward six inches of the anti-kickback/cut through device 5 rises a total of one inch, and the entire bar is oval on the sides and forward end to aid operators in sliding the device under logs on the ground. The overall length of the anti-kickback/cut through device 5 bar will be determined by three factors: One, the length of the chain guide bar 6. Two, the distance between the first stage front and back hinge mounting points on the bottom of the saw body 2, and Three, the combined total length of one and two, plus an additional six inches of length.

The anti-kickback/cut through device 5 bar will attach to the body of the saw at two hinge points. One hinge point will be located at the bottom front of the saw body 2, and the other hinge point will be located at the bottom rear of the saw body 2. The rear hinge assembly will consist of a spiral wound torsion spring 48 mounted in a spiral wound torsion spring canister 49 on the bottom mold 33 at the rear of the saw body 2. The canister will be no larger than 1¼ inches OD. The spiral wound torsion spring 48 will be centered in the spiral wound torsion spring canister 49 on an arbor, and spiral clockwise from center.

The end of the spiral wound torsion spring 48 will connect to the back of the anti-kickback/cut through device 5 via the spiral wound torsion spring connector rod 45. The spiral wound torsion spring canister 49 will be slotted from 90 degrees horizontal to approximately 180 degrees down on the forward end to provide the spring a 90 degree arc of operation. The spiral wound torsion spring 48 will keep the anti-kickback/cut through device 5 up and forward against the bottom mold 33 and guide bar 6 when not in use.

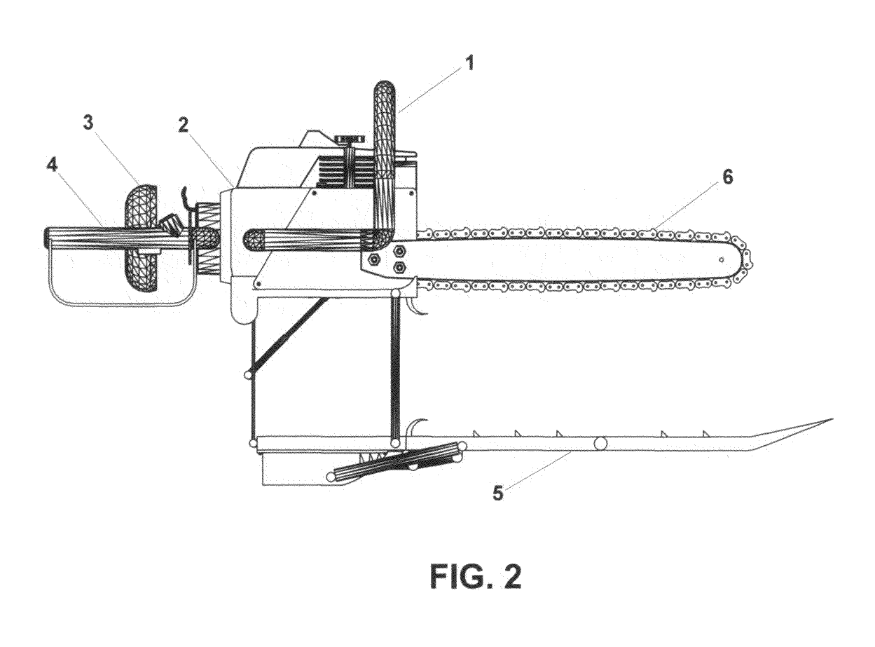

FIG. 2 is a right view of the chainsaw with stage one of the anti-kickback/cut through device 5 deployed.

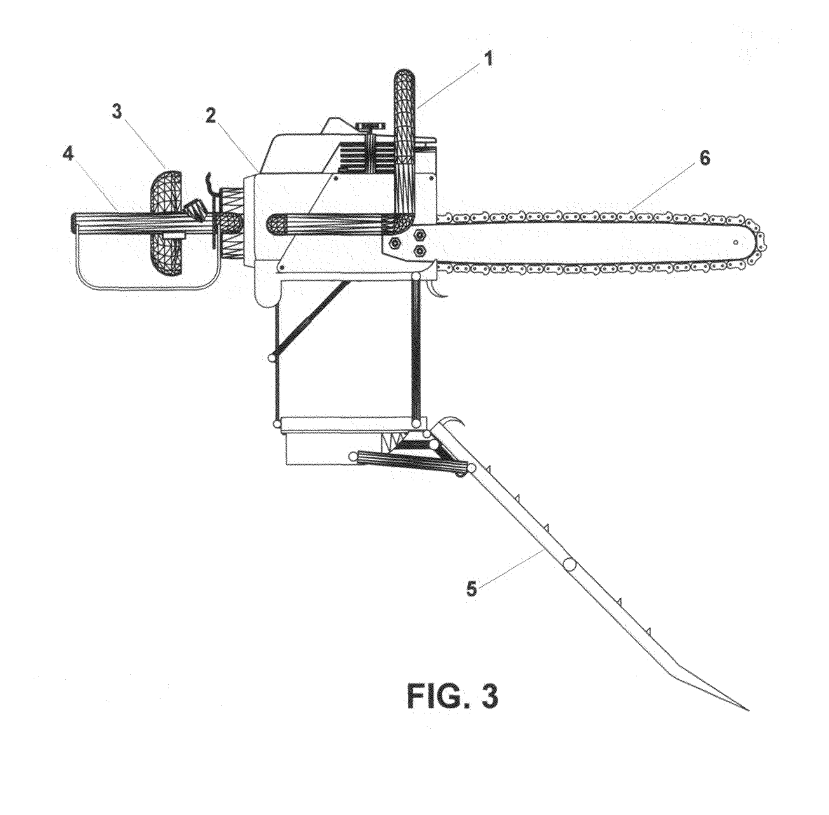

FIG. 3 is a right view of the chainsaw with stage one and two of the anti-kickback/cut through device 5 deployed.

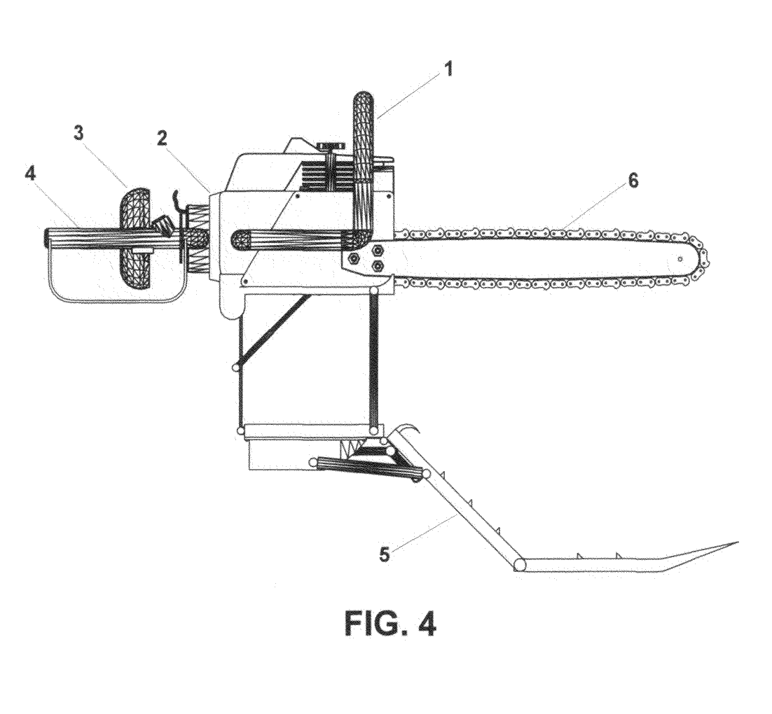

FIG. 4 is a right view of the chainsaw with stage one, two and three of the anti-kickback/cut through device 5 deployed. The stage three hinge 41 of the anti-kickback/cut through device 5 is a one way joint hinge located at the forward third of the bar that hinges upwards a total of 90 degrees. This will allow an operator cutting large logs on the ground to hold the saw on a horizontal plane while cutting. One only needs to imagine a large log between the chain and the forward part of the anti-kickback/cut through device 5 to realize the purpose and effectiveness of stage three hinge 41 of the anti-kickback/cut through device 5.

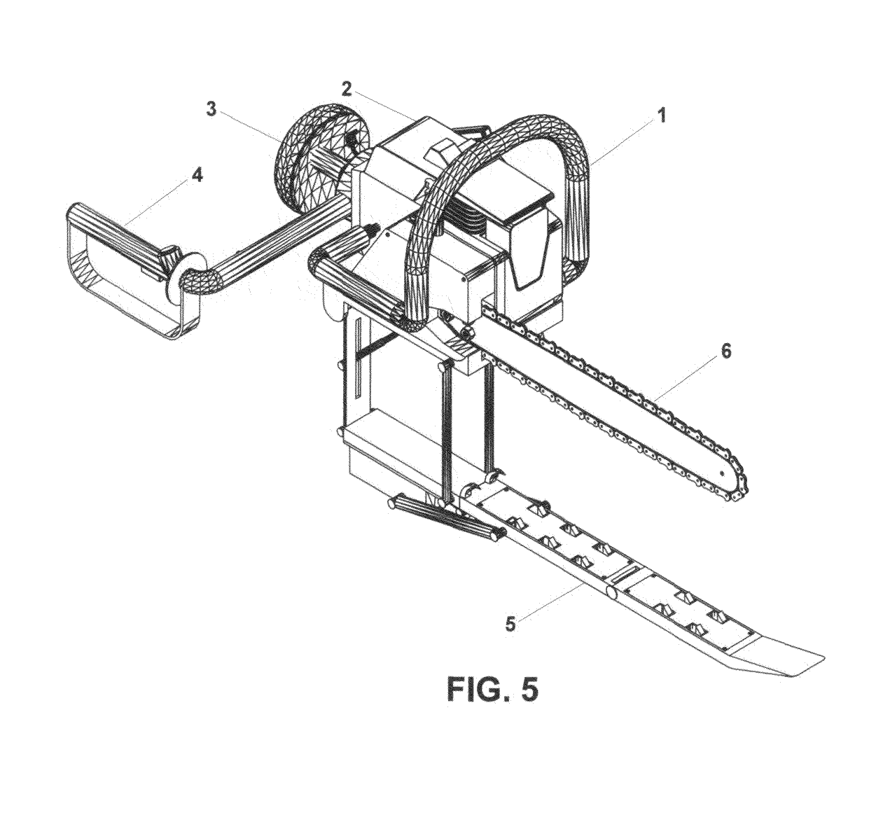

FIG. 5 is a right perspective view of the chainsaw with stage one of the anti-kickback/cut through device 5 deployed. This view gives perspective on the rear handle 4 design, the symmetrical bar handle 1, the torso pad 3 placement, and the anti-kickback/cut through device 5.

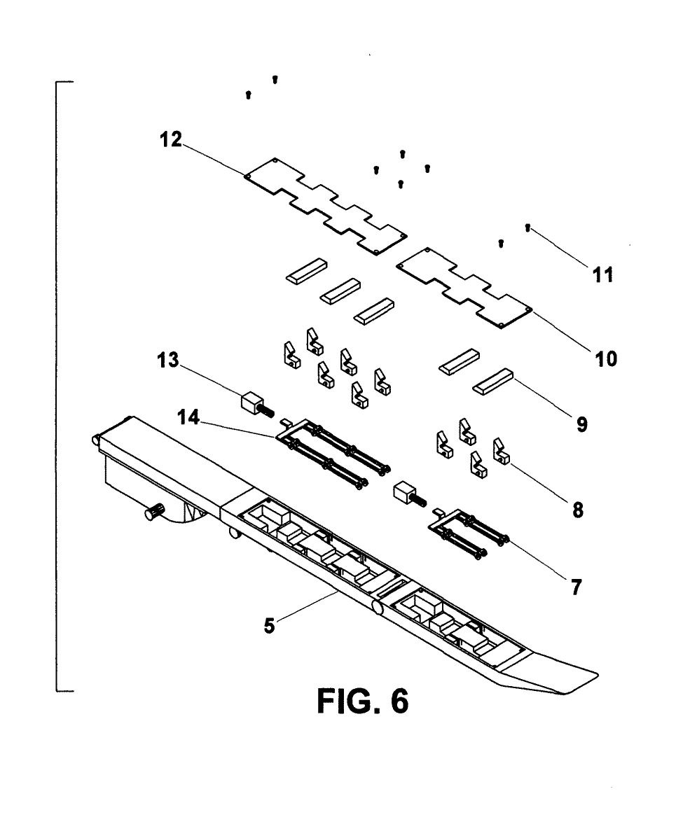

FIG. 6 is an exploded view of the anti-kickback/cut through device 5 bars internal components. The center and forward sections of the anti-kickback/cut through device 5 has been slotted out and contain the following components. Two rows of slots are cut through the bar. Each set of slots has a trapezoidal shaped bar 9 that sets sideways across the slots. Six rear facing spikes 8 are individually mounted between the center section spike lock and release bar 14, and four rear facing spikes 8 are individually mounted between the forward section spike lock and release bar 7 via an individual pin through the bottom of each rear facing spike and through the sides of the lock and release bars at the top.

The rear facing spikes 8 have a slot on the forward side that geometrically fits and locks onto the back end of the trapezoidal shaped bar 9. The rear ends of the spike lock and release bars are attached to an intermittent duty pull type DC solenoid 13. The intermittent duty pull type DC solenoid 13 is designed to have the plunger out when inactive. All the components in the center section of the anti-kickback/cut through device 5 bar are held in place and protected by the center section top plate 12, and all the components in the forward section of the anti-kickback/cut through device 5 bar are held in place and protected by the forward section top plate 10. The top plates are secured to the anti-kickback/cut through device 5 bar with the top plate screws 11.

When the intermittent duty pull type DC solenoid 13 is activated, the intermittent duty pull type DC solenoid 13 retracts the plunger, pulling the spike lock and release bars back toward the rear of the saw. The rear facing spikes 8 are disengaged from the trapezoidal shaped bar 9 and slide backward. The rear facing spikes 8 rotate on the single pin between the spike lock and release bars as it is pulled back. The front of the rear facing spikes 8 which are tapered, slides down the rear of the trapezoidal shaped bar 9 until the back side of the rear facing spikes 8 which are now the top, are horizontal. The top ⅛ inch of the rear facing spikes 8, which is now the front, lays on the rear of the trapezoidal shaped bar 9. When the rear facing spikes 8 are in the retracted position, all the rear facing spikes 8 will set below the horizontal plane of the top of the anti-kickback/cut through device 5 inside of the slots.

This is how the rear facing spikes 8 work during normal cutting operations. The rear facing spikes 8 stay erect at all times during cutting operations until the operator presses the pushbutton spike control 20 on the rear handle 4 when the anti-kickback/cut through device 5 is being pulled out from under a log or being removed from the side of a tree when the operator completes a hinge cut when felling a standing tree. When the pushbutton spike control 20 is pressed, an intermittent duty pull type DC solenoid 13 retracts it's plunger, pulling back the forward section spike lock and release bar 7 and the center section spike lock and release bar 14 to which the rear facing spikes 8 are attached.

This causes the rear facing spikes 8 to lay down in the bar slots, allowing the operator to remove the saws anti-kickback/cut through device 5 from under logs and from beside trees without interference from the rear facing spikes 8. Once the operator has removed the saw, he will release the pushbutton spike control 20 and the plunger on the intermittent duty pull type DC solenoid 13 will extend, pushing the forward section spike lock and release bar 7 and the center section spike lock and release bar 14 forward. The rear facing spikes 8 will slide up on the trapezoidal shaped bar 9 until they once again mate with, and lock onto the trapezoidal shaped bar 9. At this point the rear facing spikes 8 are locked back in the erect position.

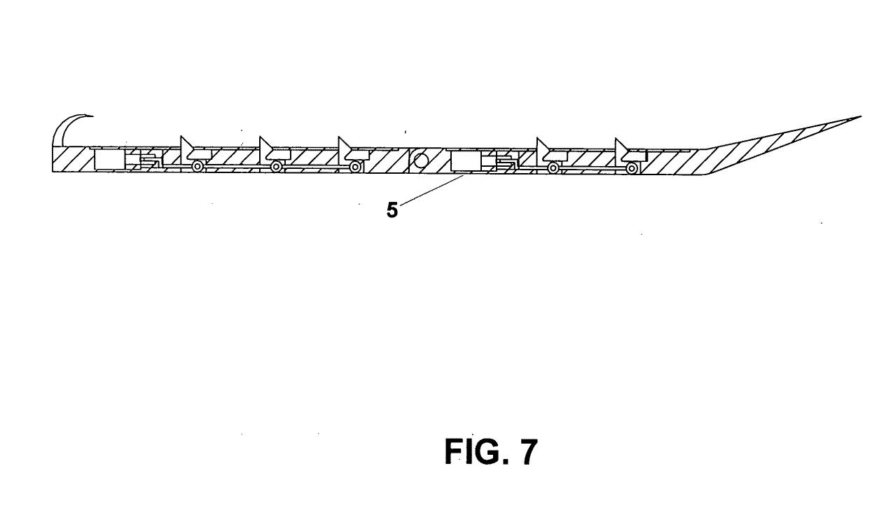

FIG. 7 is a right detail view of the forward and center sections of the anti-kickback/cut through device 5 with the rear facing spikes 8 shown erect, which is the normal position. There are six slots on the middle section of the bar and four slots on the forward section of the bar where the rear facing spikes 8 stick up out of the top of the bar. These slots reduce overall weight, and will help to drain sawdust and wood chips through the bar, therefore allowing the spikes to perform the job of gripping logs and preventing kickback motion.

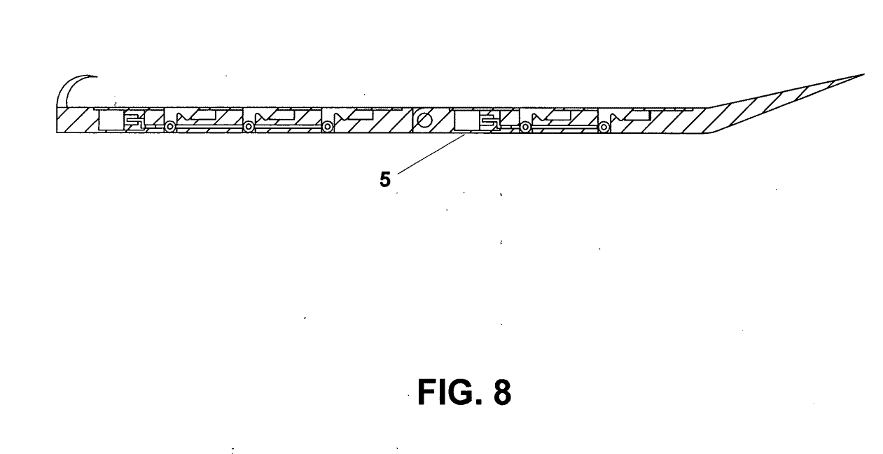

FIG. 8 is a right detail view of the froward and center sections of the anti-kickback/cut through device 5 with the rear facing spikes 8 shown in the retracted position.

Stage One: When the anti-kickback/cut through device 5 is engaged, the spiral wound torsion spring 48 will allow stage one of the anti-kickback/cut through device 5 to swing back and down. The spiral wound torsion spring 48 will also serve to keep the log or tree wedged between the anti-kickback/cut through device 5 and the blade of the saw, and to continuously push the anti-kickback/cut through device 5 back up into the closed position as the cut is being made.

The first stage hinges of the anti-kickback/cut through device 5 will consist of the spiral wound torsion spring 48, and two first stage hinge connector rods 36. The top of the first stage hinge connector rods 36 will be attached to the bottom mold 33 of the saw on a pivot mount. The bottom of the first stage hinge connector rods 36 will attach onto the sides of the anti-kickback/cut through device 5 bar just behind the stage two hinge 47 point. There will be a telescoping backstop rod 46 attached on the bottom of the bottom mold 33 via a sliding bar fitted into a slot in the bottom mold 33.

The other end of the telescoping backstop rod 46 attaches to the spiral wound torsion spring connector rod 45 half way between the spiral wound torsion spring 48 and the anti-kickback/cut through device 5 rear bar hinge on the back of the anti-kickback/cut through device 5 bar. This telescoping backstop rod 46 will keep the anti-kickback/cut through device 5 from opening any further than the intended design. This represents stage one of the three staged anti-kickback/cut through device 5.

This is how stage one of the anti-kickback/cut through device 5 will work. The operator will slide the end of the of the anti-kickback/cut through device 5 bar under a log, limb, or the side of a tree to be cut until the end of the chain almost contacts the log, tree or limb. The operator will then pull up on the saw, opening stage one of the anti-kickback/cut through device 5, and continue to slide the saw forward until the tree or log is firmly against the forward facing spikes on the bottom mold 34 at the bottom of the body of the front of the saw, and firmly against the forward facing spikes on anti-kickback/cut through device bar 40, which are located slightly behind the second stage hinge. With very little experience, engaging the item to be cut can be accomplished in one single fluid motion.

At this point, the tree or log will be sitting on the rear facing spikes 8 on the top of the anti-kickback/cut through device 5. Now the operator can begin his cut. As the cut is being made, the spiral wound torsion spring 48 will force stage one of the anti-kickback/cut through device 5 closed. Kickback will be partially prevented by the rear facing spikes 8 along the top of the anti-kickback/cut through device 5 that will inhibit the saw from being kicked back by digging into the tree, limb or log being cut. The pressure of the spiral wound torsion spring 48 will partially inhibit any upward kickback motion of the saw.

When stage one of the anti-kickback/cut through device 5 is fully hinged open, the forward six inches of length of the anti-kickback/cut through device 5 will aid in inhibiting the front of the chain from contacting another object, which could cause kickback. The presence of the anti-kickback/cut through device 5 itself will physically prevent any cut through injuries from occurring. Generally, on a chainsaw with a fourteen-inch guide bar 6, the opening of stage one of the anti-kickback/cut through device 5 will be approximately eight inches. This dimension will change depending on the size of the saw body 2, and the guide bar 6 length of each saw.

Stage Two: As operators will obviously be cutting logs and trees of larger diameter than the stage one opening of the saw, there will be a second stage of the anti-kickback/cut through device 5 which will open downward up to a total of 88 degrees from horizontal at the stage two hinge 47 that is located immediately in front of the first stage hinge connector rods 36. The second stage will consist of two stage two compression springs 37, each protected by the stage two compression spring protector sleeves 38. The forward end of the stage two compression springs 37 will be mounted onto the side of the anti-kickback/cut through device 5 approximately five inches forward of the second stage hinge which is located slightly ahead of where the first stage hinge connector rods 36 connect to the anti-kickback/cut through device 5.

The rear mount of the stage two compression springs 37 will attach onto the ambient air cylinder/flow control valve 44 cover that is located under the rear of the anti-kickback/cut through device 5. The spiral wound torsion spring 48 and the stage two compression springs 37 will be calibrated so that the first stage of the anti-kickback/cut through device 5 will fully open, before the second stage opens.

This is how stage two of the anti-kickback/cut through device 5 will work. When stage two of the anti-kickback/cut through device 5 is deployed, the downward motion of the anti-kickback/cut through device 5 will depress the stage two compression springs 37 and the ambient air cylinder/flow control valve 44 piston rod on the ambient air cylinder/flow control valve 44. The ambient air cylinder/flow control valve 44 assembly, which is located under the rear section of the anti-kickback/cut through device 5, will at most times, simply travel along as the second stage is opened and closed without interference with the operation.

However, when either stage one or two of the anti-kickback/cut through device 5 is subject to the sudden force that is created during a kickback event, the ambient air cylinder/flow control valve 44 will seize the cylinder rod, and therefore the anti-kickback/cut through device 5, instantly arresting the upwards kickback motion. The initial rear kickback motion created by the event will cause the rear facing spikes 8 on the anti-kickback/cut through device 5 to dig into the log, limb or tree being cut, therefore arresting the backwards motion. Once the kickback event is over, the flow control valve will release the cylinder rod, and therefore the anti-kickback/cut through device 5, and the operator will simply continue with the cutting operation.

Stage Three: Stage three of the anti-kickback/cut through device 5 is a one-way spring hinge that hinges up a total of 90 degrees from horizontal. The third stage hinge point is located on the bar halfway between the stage two hinge 47 and the forward end of the bar. This is how stage three will work. When the operator is cutting a large log on the ground, he will insert the bar under the log and pull up and push forward on the saw until it is on a horizontal plane. The cut can now begin. As the chain cuts through the log and the saw sinks, stage one, two and three will close at the same time, as the operator adjusts the saw to keep it horizontal while cutting. At the end of the cut the anti-kickback/cut through device 5 will be back in the closed position.

Since the body of the saw is now designed to rotate via the incremental rotational control 16, the bar will remain under the blade at all times as the device itself rotates along with the body of the saw when making angled cuts of 45 and 90 degrees to either the right or left.

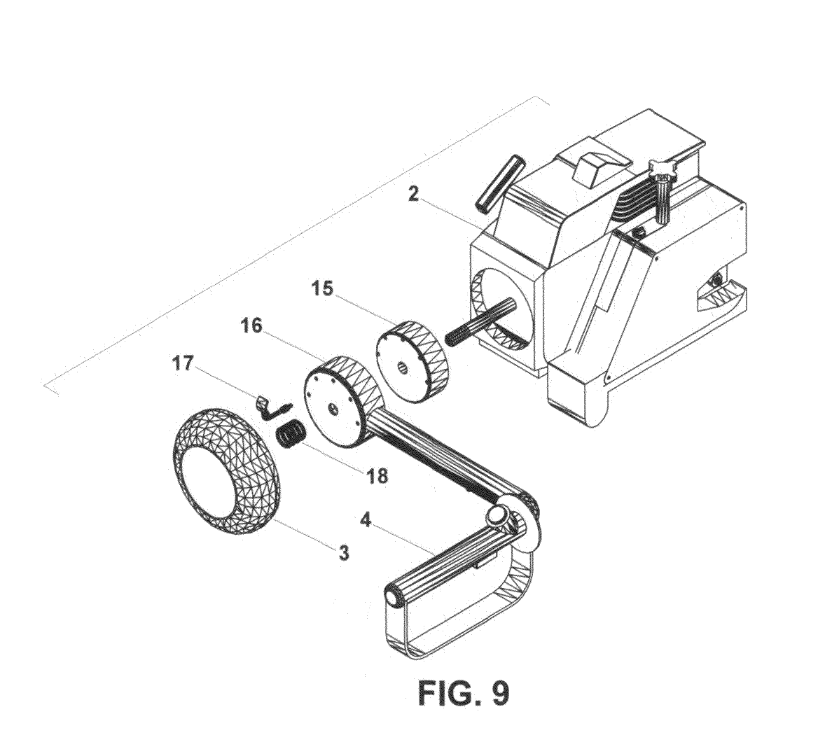

FIG. 9 is an exploded view of the incremental rotational control 16 components, rear handle 4 with throttle control 21, pushbutton spike control 20, and torso pad 3 in relation to where they connect onto the saw body 2 via a shaft that extends back and out from the body frame. The incremental rotational control 16 consist of a pinwheel 15 that connects onto a solid shaft extending back from the engine frame, and a sleeve that fits over it to which the rear handle 4 attaches. The pinwheel 15 has five shallow holes drilled in it that represent the five settings of the incremental rotational control 16. One hole is at zero degrees top dead center, one at forty-five degrees right, one at ninety degrees right, one at two hundred seventy degrees left, and one at three hundred fifteen degrees left. The incremental rotational control spring-loaded pin 17 is bullet shaped so that when it reaches the holes in the pinwheel 15, it snaps into each hole and is secured there by the pressure of the spring.

When the incremental rotational control spring-loaded pin 17 is at zero degrees top, the saw is aligned straight, and the rear handle 4 is positioned to the right. The rear handle 4 remains in that position as the incremental rotational control 16 is adjusted forty-five and ninety degrees right or left when the operator manipulates the pin and rotates the saw body 2.

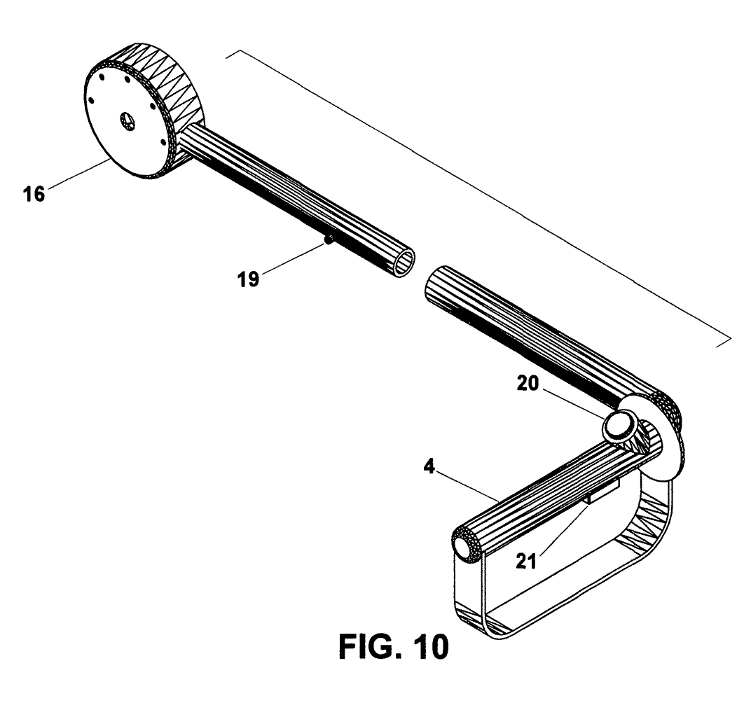

FIG. 10 is a right perspective view of the two rear handle 4 sections with the inside section of the rear handle 4 shown connected to the incremental rotational control 16. The outside section of the rear handle 4 sleeves over the inside section of the rear handle 4 and is adjusted by depressing the spring-pin adjustment mechanism 19 on the rear handle 4 horizontal tube and sliding the outside section to the desired length, then allowing the spring pin to pop through one of the adjustment holes in the outside section of the rear handle 4. The electrical wiring for the pushbutton spike control 20, and an adjustable length throttle flex control cable runs inside the rear handle 4 and through the incremental rotational control 16 and exits very close to center, and into the saw body 2.

This alignment allows for the saw body 2 rotation via the incremental rotational control 16 without damaging the control cable and electrical wire. The wiring for the pushbutton spike control 20 incorporates a small battery inside the body of the saw in order to activate the intermittent duty pull type DC solenoid 13 s in case the engine dies and electrical power from the magneto is not available. The wiring for the pushbutton spike control 20 exits the bottom of the saw through the front of the bottom mold 33 and runs through the first stage hinge connector rods 36 and in a slot through the anti-kickback/cut through device 5 to the two intermittent duty pull type DC solenoid 13. The system utilizes electrically conductive hinges at the stage two hinge 47 and stage three hinge 41 points to transfer the electrical power to the intermittent duty pull type DC solenoid 13.

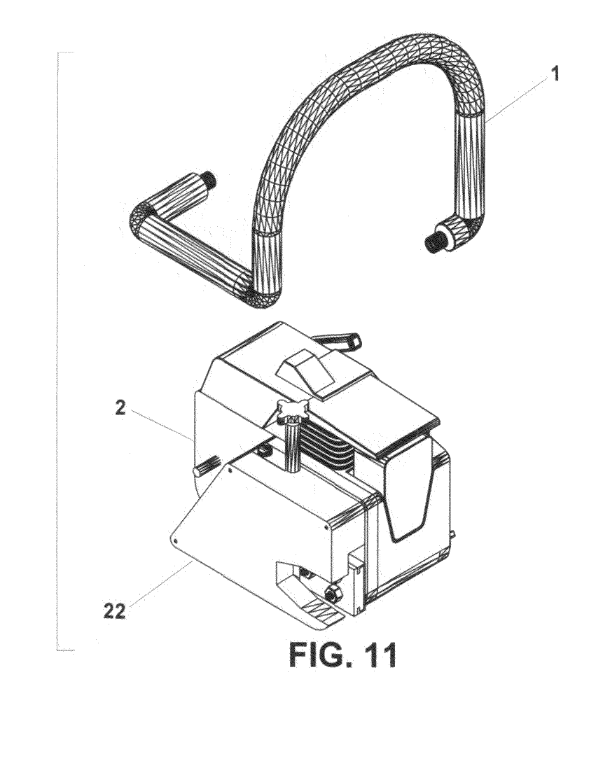

FIG. 11 is a right perspective view of the bar handle 1 in relation to the chainsaw body. The bar handle 1 forms a symmetrical loop from the attachment point on the left side of the saw, rising up over the top of the saw and down the right side till the length of the bar is the same distance vertically on both sides of the saw. The bar handle 1 then turns 90 degrees back to clear the gearbox cover 22, and then 90 degrees left to attach onto the right side of the saw. The symmetrical loop on the bar handle 1 will aid the operator in making angled cuts by giving him basically the same gripping distance by allowing him to slide his hand along the symmetrical bar handle 1 as the saw is rotated incrementally right or left.

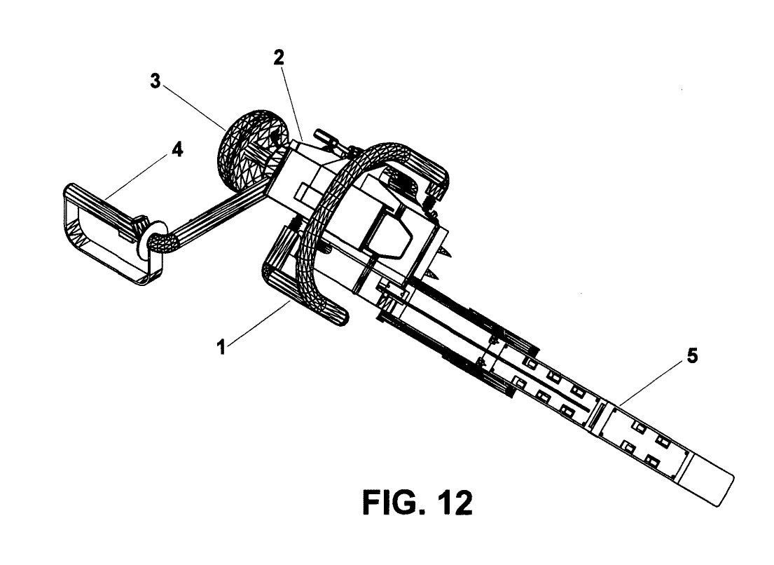

FIG. 12 is right perspective view of the chainsaw with the incremental rotational control 16 rotated 90 degrees to the right.

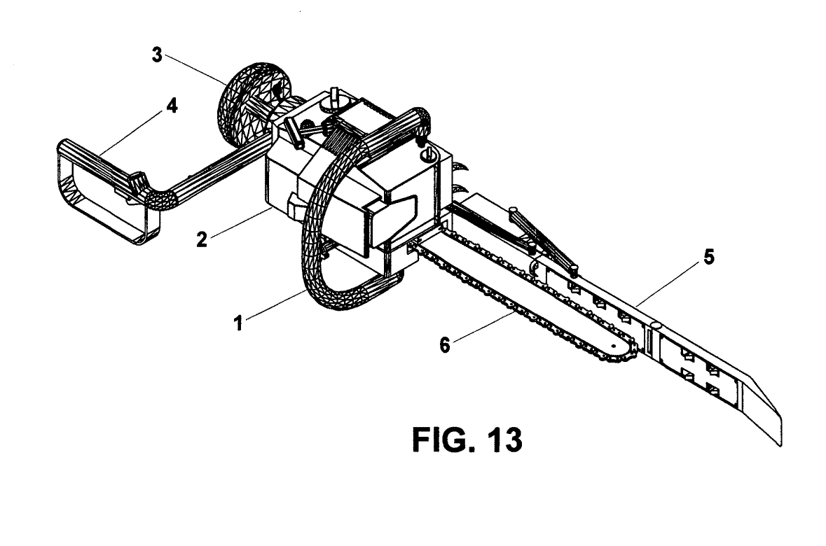

FIG. 13 is right perspective view of the chainsaw with the incremental rotational control 16 rotated 45 degrees to the right.

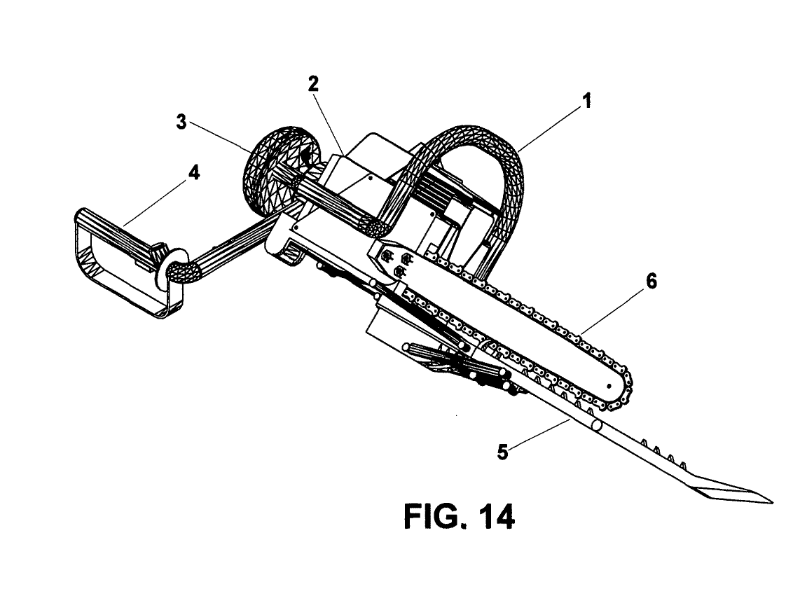

FIG. 14 is right perspective view of the chainsaw with the incremental rotational control 16 rotated 45 degrees to the left.

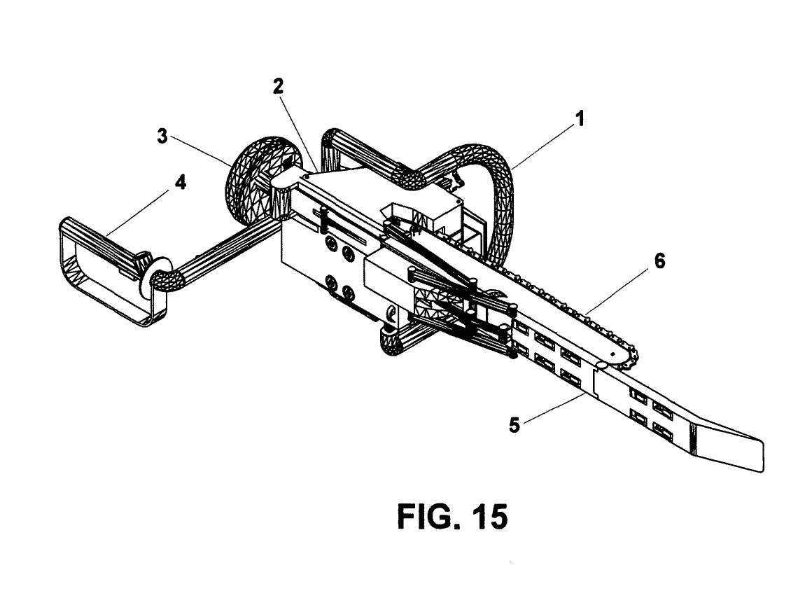

FIG. 15 is right perspective view of the chainsaw with the incremental rotational control 16 rotated 90 degrees to the left.

FIG. 16 is a exploded view of the gearbox, mechanical gear assembly 29, oil environment centrifugal clutch 30, gearbox reservoir cover plate 27, gearbox oil fill cap 32, chain tension adjustment mechanism 31, guide bar mounting plate 25, guide bar 6 and chain, guide bar mounting plate 25 adjustment slot, gearbox cover 22, and gearbox reservoir cover-plate mounting screws 23. The gearbox serves three purposes. One, it protects the mechanical gear assembly 29 and the oil environment centrifugal clutch 30 from debris and damage from the environment. Two, it provides an attachment point for the chain tension adjustment mechanism 31. Three, it provides an attachment point for the guide bar 6 plate adjustment slot.

The mechanical gear assembly 29 is as follows. The upper mechanical gear is welded onto the oil environment centrifugal clutch 30 hub. The gears do not spin to drive the chain until the RPM's are increased sufficiently to activate the clutch. The upper mechanical gear turns the same direction of the engine drive shaft, clockwise. The upper mechanical gear turns the middle mechanical gear counterclockwise, which turns the lower mechanical gear clockwise. The lower mechanical gear rides on a shaft that extends horizontally through a sealed bearing in the gearbox reservoir cover plate.

The chain sprocket 28 is attached onto this shaft. The shaft turns the same direction as the upper mechanical gear, pulling the bottom of the chain toward the saw. The purpose of the mechanical gear assembly 29 arrangement is to lower the chain sprocket 28 and guide bar 6 sufficiently so that the chain sets approximately 3/32 of an inch above the anti-kickback/cut through device 5. This in turn positions the bar at a lower point, making it easier for the operator to slide the anti-kickback/cut through device 5 under logs on the ground.

The guide bar mounting plate 25 has three studs in a triangular pattern to fit the holes on the guide bar 6 itself. The guide bar 6 is bolted onto the guide bar mounting plate 25 and the guide bar mounting plate 25 is inserted into the guide bar mounting plate 25 adjustment slot, which is located on the lower front of the gearbox reservoir cover plate 27. The gearbox reservoir cover plate and gearbox cover 22 is secured with the gearbox reservoir cover plate screws 23. The guide bar mounting plate 25 then slides as close as possible to the chain sprocket 28, and the chain is looped over the sprocket. The chain tension adjustment mechanism 31 is then used to adjust the tension on the chain by pushing the guide bar mounting plate 25 until the correct tension is achieved. Turning the knob on the chain tension adjustment mechanism 31 loosens and tightens the chain. This chain tension adjustment mechanism 31 sets between the guide bar mounting plate adjusting slot 26 and the chain sprocket 28. Adjustment is made via either a worm and pinion gear or a scissor type gear. The size of the chainsaw may place a limitation on what type of gear can be used.

This will eliminate chain slack common to current designs of guide bars with sliding adjustment slots that become worn and loose over time, and due to operators reluctance to shut down cutting operations and spend the time necessary to tighten the chain with hand tools. Because the chain will set above the anti-kickback/cut through device 5, it will not dig into the dirt causing the chain to lose sharpness or wear out due to dirt granules constantly grinding on the chain parts. Because of the guide bar mounting plate 25 design, operators will no longer have to carry tools with which to loosen and tighten nuts in order to adjust chain tension.

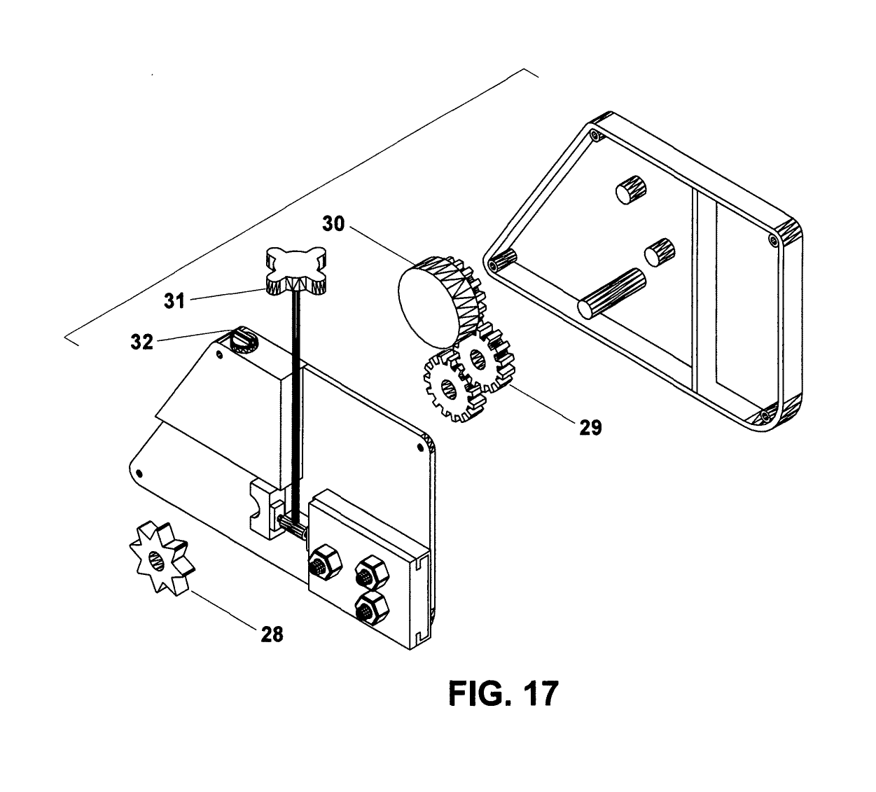

FIG. 17 is an exploded view of the gearbox, mechanical gear assembly 29, oil environment centrifugal clutch 30, chain tension adjustment mechanism 31, guide bar mounting plate 25 setting in the guide bar mounting plate 25 adjustment slot, the oil fill cap, and the chain sprocket 28.

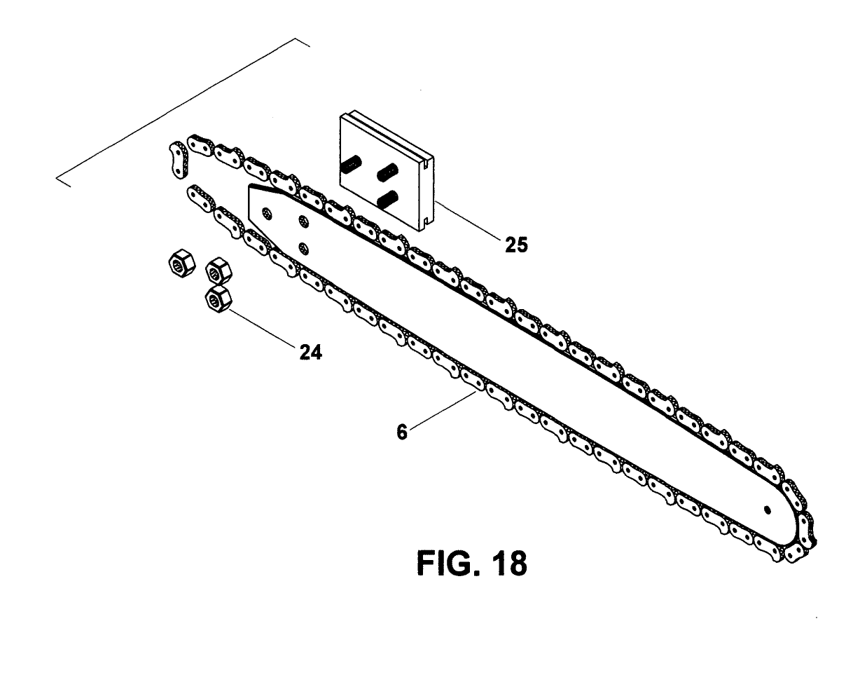

FIG. 18 is an exploded view of the mechanical gear assembly 29, guide bar mounting plate 25, guide bar 6 and chain, and the guide bar mounting plate nuts 24 This view shows how the guide bar 6 and chain will mount onto the guide bar mounting plate 25. The mechanical gear assembly 29 is exploded out so the shaft arrangement is visible, and the guide bar mounting plate 25 is shown inserted into the guide bar mounting plate 25 adjustment slot.

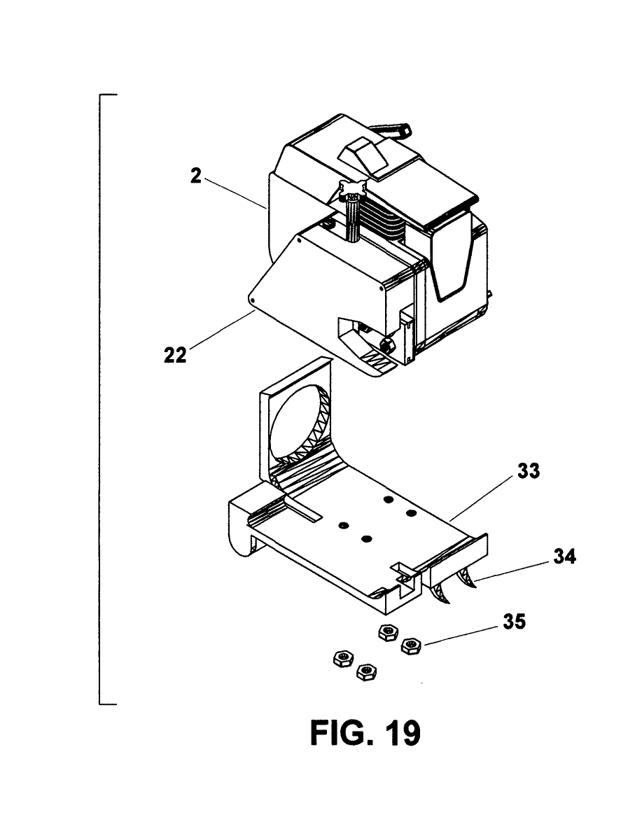

FIG. 19 is a right perspective view of the bottom mold 33 and the saw body 2 to which it attaches. The bottom mold 33 will be made of a hard plastic. This mold may be formed in one of two ways. One, via a molded frame as shown, which will be bolted onto undercarriage of the body of the saw. Two, via a mold, which will be incorporated into the body of the saw itself by the manufacturer. For the purpose of this presentation, the drawings illustrate a molded frame that attaches to the bottom of an existing chainsaw. The drawing shows the gearbox cover 22 attached to the saw body 2, the forward facing spikes on the bottom mold 34, and the bottom mold nuts 35, with which it is attached to the saw body 2.

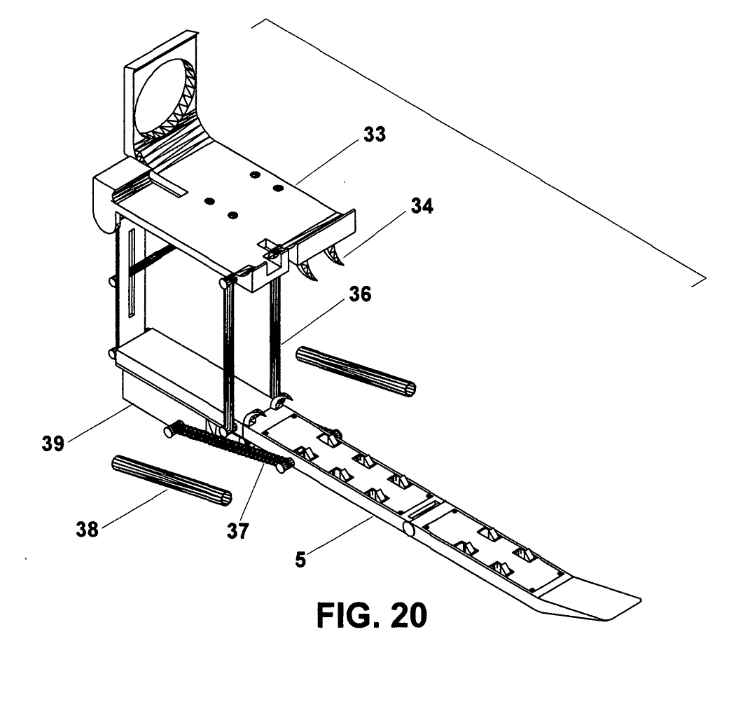

FIG. 20 is a right perspective view of the bottom mold 33 with stage one of the anti-kickback/cut through device 5 deployed. In this view the stage two compression springs 37 are visible as the stage two compression spring protector sleeves 38 are exploded out.

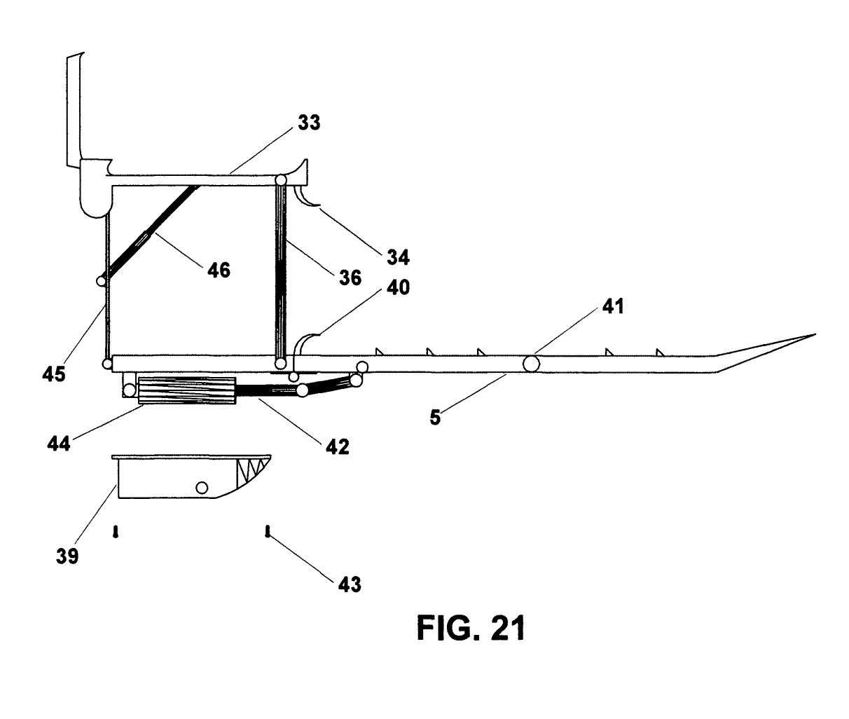

FIG. 21 is a right view of the bottom mold 33 with stage one of the anti-kickback/cut through device 5 deployed. The ambient air cylinder/flow control valve 44 is visible as the ambient air cylinder/flow control valve protective cover 39 is exploded out. The anti-kickback/cut through device 5 telescoping backstop rod 46 is visible. The telescoping backstop rod 46 is shown fully deployed into a forty-five degree angle from the bottom mold 33 to the center of the spiral wound torsion spring 48 connector.

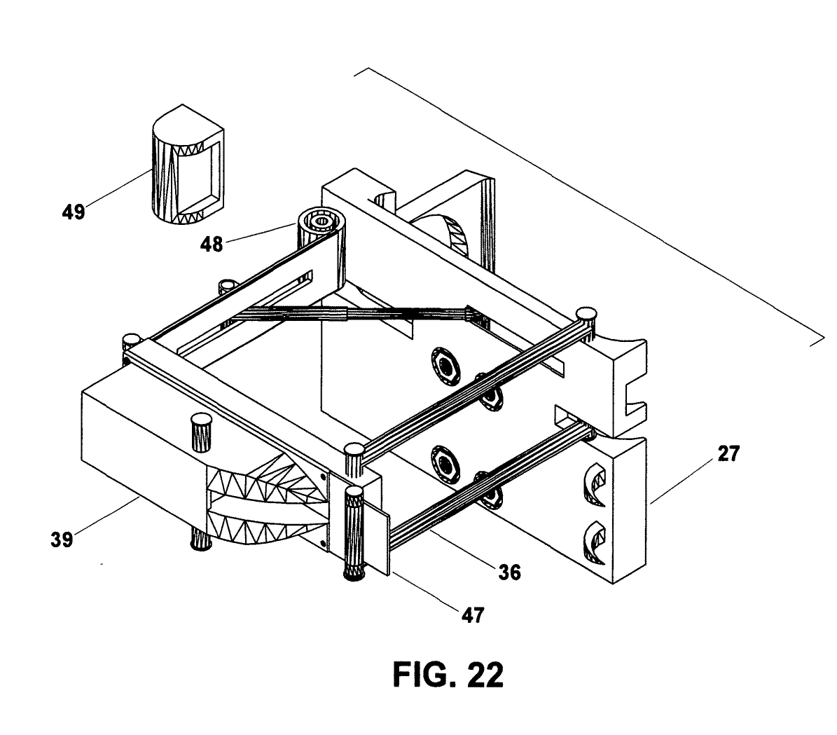

FIG. 22 is a bottom view of the bottom mold 33 and rear section of the anti-kickback/cut through device 5, The anti-kickback/cut through device 5 telescoping backstop rod 46 is connected to the bottom mold 33 via small plate mounted into a slot that allows it the proper travel distance. When stage one of the anti-kickback/cut through device 5 closes, the telescoping backstop rod 46 connection in the bottom mold 33 slides forward, while at the same time, the telescoping rod closes to it's shortest length and lays behind the sliding plate and into the slot inside the bottom mold 33. The spiral wound torsion spring canister 49 is exploded to give a view of the spiral wound torsion spring 48. However it should be noted that the spiral wound torsion spring canister 49 is part of the bottom mold 33.

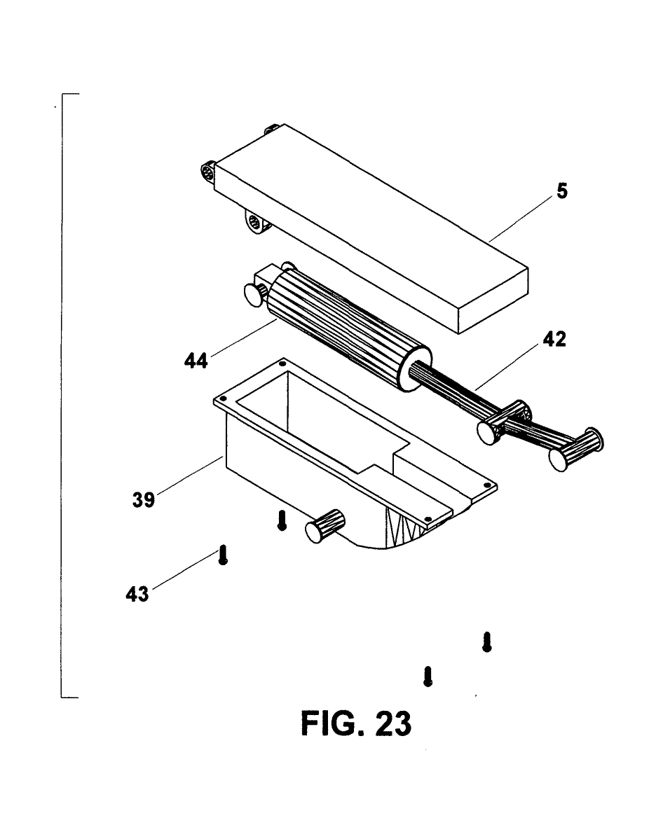

FIG. 23 is an exploded view of the ambient air cylinder/flow control valve 44, ambient air cylinder/flow control valve protective cover 39 ambient air cylinder/flow control valve protective cover mounting screws 43, and the rear section of the anti-kickback/cut through device 5 to which it attaches. The ambient air cylinder piston rod 42 is also shown.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A kct injury prevention chain saw for a “kct injury prevention chain saw” for: reducing or eliminating kickback and cut through injuries associated with chainsaw operations, comprising:
means for the operator to grip the handle in the same way no matter which degree of direction the saw body is turned;
means for bracing the back of the saw against the operators torso;
means for provision of an ergonomic grip for the operator and to keep the saw straight away forward from the operator;
means for prevention of kickback and cut through injuries;
means for quick adjustment of the chain;
means for sliding back to unlock the rear facing spikes on the forward section of the anti-kickback/cut through device bar so they can lay down in a horizontal position, and sliding forward to lock the rear facing spikes in a vertical position, rigidly connected to said means for prevention of kickback and cut through injuries;
means for gripping and releasing logs and trees setting on the anti-kickback/cut through device bar, rigidly connected to said means for sliding back to unlock the rear facing spikes on the forward section of the anti-kickback/cut through device bar so they can lay down in a horizontal position, and sliding forward to lock the rear facing spikes in a vertical position;
means for the rear facing spikes to lslide up and down on when being repositioned from vertical to horizontal, and to lock onto when in the vertical position;
means for securing and protecting the internal components within the forward section of the anti-kickback/cut through bar, rigidly connected to said means for sliding back to unlock the rear facing spikes on the forward section of the anti-kickback/cut through device bar so they can lay down in a horizontal position, and sliding forward to lock the rear facing spikes in a vertical position;
means for securing the top plates on the center and forward section of the anti-kickback/cut through device bar, rigidly connected to said means for securing and protecting the internal components within the forward section of the anti-kickback/cut through bar;
means for securing and protecting the internal components within the center section of the anti-kickback/cut through device bar, rigidly connected to said means for securing the top plates on the center and forward section of the anti-kickback/cut through device bar, and rigidly connected to said means for the rear facing spikes to lslide up and down on when being repositioned from vertical to horizontal, and to lock onto when in the vertical position;
means for pulling the spike lock and release bars back so the rear facing spikes lay horizontal, rigidly connected to said means for the rear facing spikes to lslide up and down on when being repositioned from vertical to horizontal, and to lock onto when in the vertical position;
means for adjusting the rear handle horizontally, rigidly connected to said means for provision of an ergonomic grip for the operator and to keep the saw straight away forward from the operator;
means for providing the locking mechanism for rotating the chainsaw incrementally as the pin is transferred between the holes in the pinwheel;
means for changing the angle of the saw incrementally either 45 or 90 degrees right or left while keeping the handles and grip in the same position when making angled cuts, rigidly connected to said means for providing the locking mechanism for rotating the chainsaw incrementally as the pin is transferred between the holes in the pinwheel, and rigidly connected to said means for provision of an ergonomic grip for the operator and to keep the saw straight away forward from the operator;
means for sliding back and releasing the rear facing spikes on the center section of the anti-kickback/cut through device bar, so they can lay down in a horizontal position, and sliding forward to move the spikes into a vertical position and locking them in that position, rigidly connected to said means for the rear facing spikes to lslide up and down on when being repositioned from vertical to horizontal, and to lock onto when in the vertical position, and rigidly connected to said means for gripping and releasing logs and trees setting on the anti-kickback/cut through device bar;
means for locking the incremental rotational control at various angles in order to make angled cuts, rigidly connected to said means for changing the angle of the saw incrementally either 45 or 90 degrees right or left while keeping the handles and grip in the same position when making angled cuts;
means for allowing the torso pad to flex when the saw kicks back during cutting operations, rigidly connected to said means for bracing the back of the saw against the operators torso;
means for releasing the rear facing spikes on the anti-kickback/cut through bar when removing the bar from under logs or beside a standing tree when cutting a felling hinge, rigidly connected to said means for provision of an ergonomic grip for the operator and to keep the saw straight away forward from the operator;
means for controlling the engine speed, rigidly connected to said means for provision of an ergonomic grip for the operator and to keep the saw straight away forward from the operator;
means for provision of a protective cover for the gearbox and chain tension adjustment mechanism;
means for attaching the guide bar to the guide bar adjustment plate;
means for attaching the guide bar onto, rigidly connected to said means for quick adjustment of the chain;
means for securing the gearbox reservoir cover to the gearbox;
means for turning the shaft that turns the chain sprocket;
means for transferring power from the engine when it reaches a certain rpm, and stopping power transfer from the engine when the chain binds, rigidly connected to said means for turning the shaft that turns the chain sprocket;
means for providing an easy adjustment of the chain, rigidly connected to said means for provision of a protective cover for the gearbox and chain tension adjustment mechanism, and rigidly connected to said means for quick adjustment of the chain;
means for sealing the gearbox and protecting the oil environment centrifugal clutch and mechanical gears;
means for providing a platform for mounting the incremental rotational control and the anti-kickback/cut through device bar;
means for keeping items being cut from impeding operation of the anti-kickback/cut through device and provide a pivot point to rock the saw on during cutting in order to clear debris from the chain, rigidly connected to said means for providing a platform for mounting the incremental rotational control and the anti-kickback/cut through device bar;
means for allowing the first stage of the anti-kickback/cut through device to pivot down and back when deployed, rigidly connected to said means for providing a platform for mounting the incremental rotational control and the anti-kickback/cut through device bar, and rigidly connected to said means for prevention of kickback and cut through injuries;
means for pushing the anti-kickback/cut through device bar back up into the closed position as a cut is being made when stage two is deployed;
means for protecting the stage two compression springs from damage and debris;
means for protecting the ambient air cylinder/flow control valve from damage;
means for preventing items being cut from contacting the first stage hinge connector rods and damaging them or impeding the operation of same, rigidly connected to said means for prevention of kickback and cut through injuries;
means for allow the forward end of the anti-kickback/cut through device bar to hinge up when operators are cutting large logs on the ground;
means for operation of the ambient air cylinder/flow control valve when stage two of the anti-kickback/cut through device is deployed, rigidly connected to said means for protecting the ambient air cylinder/flow control valve from damage;
means for seizing the anti-kickback device when a sudden pressure is applied during a kickback event, rigidly connected to said means for protecting the ambient air cylinder/flow control valve from damage, and rigidly connected to said means for pushing the anti-kickback/cut through device bar back up into the closed position as a cut is being made when stage two is deployed;
means for connecting the spiral wound torsion spring to the back of the anti-kickback/cut through device bar and providing pressure for closing same as a stage one cut is being completed;
means for preventing stage one of the anti-kick/cut through device from swinging further back than it was designed, rigidly connected to said means for providing a platform for mounting the incremental rotational control and the anti-kickback/cut through device bar, and rigidly connected to said means for prevention of kickback and cut through injuries;
means for allowing stage two of the anti-kickback/cut through device to open and close, rigidly connected to said means for allow the forward end of the anti-kickback/cut through device bar to hinge up when operators are cutting large logs on the ground, rigidly connected to said means for preventing items being cut from contacting the first stage hinge connector rods and damaging them or impeding the operation of same, and rigidly connected to said means for pushing the anti-kickback/cut through device bar back up into the closed position as a cut is being made when stage two is deployed;
means for closing stage one of the anti-kickback/cut through device when it is deployed, rigidly connected to said means for preventing stage one of the anti-kick/cut through device from swinging further back than it was designed; and
means for protecting the spiral wound torsion spring, rigidly connected to said means for closing stage one of the anti-kickback/cut through device when it is deployed.

2. The kct injury prevention chain saw in accordance with claim 1, wherein said means for the operator to grip the handle in the same way no matter which degree of direction the saw body is turned comprises a bar handle.

3. The kct injury prevention chain saw in accordance with claim 1, wherein said means for bracing the back of the saw against the operators torso comprises a torso pad.

4. The kct injury prevention chain saw in accordance with claim 1, wherein said means for provision of an ergonomic grip for the operator and to keep the saw straight away forward from the operator comprises a rear handle.

5. The kct injury prevention chain saw in accordance with claim 1, wherein said means for prevention of kickback and cut through injuries comprises an anti-kickback/cut through device.

6. The kct injury prevention chain saw in accordance with claim 1, wherein said means for quick adjustment of the chain comprises a guide bar.

7. The kct injury prevention chain saw in accordance with claim 1, wherein said means for sliding back to unlock the rear facing spikes on the forward section of the anti-kickback/cut through device bar so they can lay down in a horizontal position, and sliding forward to lock the rear facing spikes in a vertical position comprises a forward section spike lock and release bar.

8. The kct injury prevention chain saw in accordance with claim 1, wherein said means for gripping and releasing logs and trees setting on the anti-kickback/cut through device bar comprises a rear facing spikes.

9. The kct injury prevention chain saw in accordance with claim 1, wherein said means for the rear facing spikes to lslide up and down on when being repositioned from vertical to horizontal, and to lock onto when in the vertical position comprises a trapezoidal shaped bar.

10. The kct injury prevention chain saw in accordance with claim 1, wherein said means for securing and protecting the internal components within the forward section of the anti-kickback/cut through bar comprises a forward section top plate.

11. The kct injury prevention chain saw in accordance with claim 1, wherein said means for securing the top plates on the center and forward section of the anti-kickback/cut through device bar comprises a top plate screws.

12. The kct injury prevention chain saw in accordance with claim 1, wherein said means for securing and protecting the internal components within the center section of the anti-kickback/cut through device bar comprises a center section top plate.

13. The kct injury prevention chain saw in accordance with claim 1, wherein said means for pulling the spike lock and release bars back so the rear facing spikes lay horizontal comprises an intermittent duty pull type dc solenoid.

14. The kct injury prevention chain saw in accordance with claim 1, wherein said means for adjusting the rear handle horizontally comprises a spring-pin adjustment mechanism.

15. The kct injury prevention chain saw in accordance with claim 1, wherein said means for providing the locking mechanism for rotating the chainsaw incrementally as the pin is transferred between the holes in the pinwheel comprises a pinwheel.

16. The kct injury prevention chain saw in accordance with claim 1, wherein said means for changing the angle of the saw incrementally either 45 or 90 degrees right or left while keeping the handles and grip in the same position when making angled cuts comprises an incremental rotational control.

17. The kct injury prevention chain saw in accordance with claim 1, wherein said means for sliding back and releasing the rear facing spikes on the center section of the anti-kickback/cut through device bar, so they can lay down in a horizontal position, and sliding forward to move the spikes into a vertical position and locking them in that position comprises a center section spike lock and release bar.

18. The kct injury prevention chain saw in accordance with claim 1, wherein said means for locking the incremental rotational control at various angles in order to make angled cuts comprises an incremental rotational control spring-loaded pin.

19. The kct injury prevention chain saw in accordance with claim 1, wherein said means for allowing the torso pad to flex when the saw kicks back during cutting operations comprises a torso pad pin spring mount.

20. The kct injury prevention chain saw in accordance with claim 1, wherein said means for releasing the rear facing spikes on the anti-kickback/cut through bar when removing the bar from under logs or beside a standing tree when cutting a felling hinge comprises a pushbutton spike control.

21. The kct injury prevention chain saw in accordance with claim 1, wherein said means for controlling the engine speed comprises a throttle control.

22. The kct injury prevention chain saw in accordance with claim 1, wherein said means for provision of a protective cover for the gearbox and chain tension adjustment mechanism comprises a gearbox cover.

23. The kct injury prevention chain saw in accordance with claim 1, wherein said means for attaching the guide bar to the guide bar adjustment plate comprises a guide bar mounting plate nuts.

24. The kct injury prevention chain saw in accordance with claim 1, wherein said means for attaching the guide bar onto comprises a guide bar mounting plate.

25. The kct injury prevention chain saw in accordance with claim 1, wherein said means for securing the gearbox reservoir cover to the gearbox comprises a gearbox reservoir cover-plate mounting screws.

26. The kct injury prevention chain saw in accordance with claim 1, wherein said means for turning the shaft that turns the chain sprocket comprises a mechanical gear assembly.

27. The kct injury prevention chain saw in accordance with claim 1, wherein said means for transferring power from the engine when it reaches a certain rpm, and stopping power transfer from the engine when the chain binds comprises an oil environment centrifugal clutch.

28. The kct injury prevention chain saw in accordance with claim 1, wherein said means for providing an easy adjustment of the chain comprises a chain tension adjustment mechanism.

29. The kct injury prevention chain saw in accordance with claim 1, wherein said means for sealing the gearbox and protecting the oil environment centrifugal clutch and mechanical gears comprises a gearbox reservoir cover plate.

30. The kct injury prevention chain saw in accordance with claim 1, wherein said means for providing a platform for mounting the incremental rotational control and the anti-kickback/cut through device bar comprises a bottom mold.

31. The kct injury prevention chain saw in accordance with claim 1, wherein said means for keeping items being cut from impeding operation of the anti-kickback/cut through device and provide a pivot point to rock the saw on during cutting in order to clear debris from the chain comprises a forward facing spikes on the bottom mold.

32. The kct injury prevention chain saw in accordance with claim 1, wherein said means for allowing the first stage of the anti-kickback/cut through device to pivot down and back when deployed comprises a first stage hinge connector rods.

33. The kct injury prevention chain saw in accordance with claim 1, wherein said means for pushing the anti-kickback/cut through device bar back up into the closed position as a cut is being made when stage two is deployed comprises a stage two compression springs.

34. The kct injury prevention chain saw in accordance with claim 1, wherein said means for protecting the stage two compression springs from damage and debris comprises a stage two compression spring protector sleeves.

35. The kct injury prevention chain saw in accordance with claim 1, wherein said means for protecting the ambient air cylinder/flow control valve from damage comprises an ambient air cylinder/flow control valve protective cover.

36. The kct injury prevention chain saw in accordance with claim 1, wherein said means for preventing items being cut from contacting the first stage hinge connector rods and damaging them or impeding the operation of same comprises a forward facing spikes on anti-kickback/cut through device bar.

37. The kct injury prevention chain saw in accordance with claim 1, wherein said means for allow the forward end of the anti-kickback/cut through device bar to hinge up when operators are cutting large logs on the ground comprises a stage three hinge.

38. The kct injury prevention chain saw in accordance with claim 1, wherein said means for operation of the ambient air cylinder/flow control valve when stage two of the anti-kickback/cut through device is deployed comprises an ambient air cylinder piston rod.

39. The kct injury prevention chain saw in accordance with claim 1, wherein said means for seizing the anti-kickback device when a sudden pressure is applied during a kickback event comprises an ambient air cylinder/flow control valve.

40. The kct injury prevention chain saw in accordance with claim 1, wherein said means for connecting the spiral wound torsion spring to the back of the anti-kickback/cut through device bar and providing pressure for closing same as a stage one cut is being completed comprises a spiral wound torsion spring connector rod.

41. The kct injury prevention chain saw in accordance with claim 1, wherein said means for preventing stage one of the anti-kick/cut through device from swinging further back than it was designed comprises a telescoping backstop rod.

42. The kct injury prevention chain saw in accordance with claim 1, wherein said means for allowing stage two of the anti-kickback/cut through device to open and close comprises a stage two hinge.

43. The kct injury prevention chain saw in accordance with claim 1, wherein said means for closing stage one of the anti-kickback/cut through device when it is deployed comprises a spiral wound torsion spring.

44. The kct injury prevention chain saw in accordance with claim 1, wherein said means for protecting the spiral wound torsion spring comprises a spiral wound torsion spring canister.

45. A kct injury prevention chain saw for a “kct injury prevention chain saw” for: reducing or eliminating kickback and cut through injuries associated with chainsaw operations, comprising:
a bar handle, for the operator to grip the handle in the same way no matter which degree of direction the saw body is turned;
a torso pad, for bracing the back of the saw against the operators torso;
a rear handle, for provision of an ergonomic grip for the operator and to keep the saw straight away forward from the operator;
an anti-kickback/cut through device, for prevention of kickback and cut through injuries;
a guide bar, for quick adjustment of the chain;
a forward section spike lock and release bar, for sliding back to unlock the rear facing spikes on the forward section of the anti-kickback/cut through device bar so they can lay down in a horizontal position, and sliding forward to lock the rear facing spikes in a vertical position, rigidly connected to said anti-kickback/cut through device;
a rear facing spikes, for gripping and releasing logs and trees setting on the anti-kickback/cut through device bar, rigidly connected to said forward section spike lock and release bar;
a trapezoidal shaped bar, for the rear facing spikes to lslide up and down on when being repositioned from vertical to horizontal, and to lock onto when in the vertical position;
a forward section top plate, for securing and protecting the internal components within the forward section of the anti-kickback/cut through bar, rigidly connected to said forward section spike lock and release bar;
a top plate screws, for securing the top plates on the center and forward section of the anti-kickback/cut through device bar, rigidly connected to said forward section top plate;
a center section top plate, for securing and protecting the internal components within the center section of the anti-kickback/cut through device bar, rigidly connected to said top plate screws, and rigidly connected to said trapezoidal shaped bar;
an intermittent duty pull type dc solenoid, for pulling the spike lock and release bars back so the rear facing spikes lay horizontal, rigidly connected to said trapezoidal shaped bar;
a spring-pin adjustment mechanism, for adjusting the rear handle horizontally, rigidly connected to said rear handle;
a pinwheel, for providing the locking mechanism for rotating the chainsaw incrementally as the pin is transferred between the holes in the pinwheel;
an incremental rotational control, for changing the angle of the saw incrementally either 45 or 90 degrees right or left while keeping the handles and grip in the same position when making angled cuts, rigidly connected to said pinwheel, and rigidly connected to said rear handle;
a center section spike lock and release bar, for sliding back and releasing the rear facing spikes on the center section of the anti-kickback/cut through device bar, so they can lay down in a horizontal position, and sliding forward to move the spikes into a vertical position and locking them in that position, rigidly connected to said trapezoidal shaped bar, and rigidly connected to said rear facing spikes;
an incremental rotational control spring-loaded pin, for locking the incremental rotational control at various angles in order to make angled cuts, rigidly connected to said incremental rotational control;
a torso pad pin spring mount, for allowing the torso pad to flex when the saw kicks back during cutting operations, rigidly connected to said torso pad;
a pushbutton spike control, for releasing the rear facing spikes on the anti-kickback/cut through bar when removing the bar from under logs or beside a standing tree when cutting a felling hinge, rigidly connected to said rear handle;
a throttle control, for controlling the engine speed, rigidly connected to said rear handle;
a gearbox cover, for provision of a protective cover for the gearbox and chain tension adjustment mechanism;
a guide bar mounting plate nuts, for attaching the guide bar to the guide bar adjustment plate;
a guide bar mounting plate, for attaching the guide bar onto, rigidly connected to said guide bar;
a gearbox reservoir cover-plate mounting screws, for securing the gearbox reservoir cover to the gearbox;
a mechanical gear assembly, for turning the shaft that turns the chain sprocket;
an oil environment centrifugal clutch, for transferring power from the engine when it reaches a certain rpm, and stopping power transfer from the engine when the chain binds, rigidly connected to said mechanical gear assembly;
a chain tension adjustment mechanism, for providing an easy adjustment of the chain, rigidly connected to said gearbox cover, and rigidly connected to said guide bar;
a gearbox reservoir cover plate, for sealing the gearbox and protecting the oil environment centrifugal clutch and mechanical gears;
a bottom mold, for providing a platform for mounting the incremental rotational control and the anti-kickback/cut through device bar;
a forward facing spikes on the bottom mold, for keeping items being cut from impeding operation of the anti-kickback/cut through device and provide a pivot point to rock the saw on during cutting in order to clear debris from the chain, rigidly connected to said bottom mold;
a first stage hinge connector rods, for allowing the first stage of the anti-kickback/cut through device to pivot down and back when deployed, rigidly connected to said bottom mold, and rigidly connected to said anti-kickback/cut through device;
a stage two compression springs, for pushing the anti-kickback/cut through device bar back up into the closed position as a cut is being made when stage two is deployed;
a stage two compression spring protector sleeves, for protecting the stage two compression springs from damage and debris;
an ambient air cylinder/flow control valve protective cover, for protecting the ambient air cylinder/flow control valve from damage;
a forward facing spikes on anti-kickback/cut through device bar, for preventing items being cut from contacting the first stage hinge connector rods and damaging them or impeding the operation of same, rigidly connected to said anti-kickback/cut through device;
a stage three hinge, for allow the forward end of the anti-kickback/cut through device bar to hinge up when operators are cutting large logs on the ground;
an ambient air cylinder piston rod, for operation of the ambient air cylinder/flow control valve when stage two of the anti-kickback/cut through device is deployed, rigidly connected to said ambient air cylinder/flow control valve protective cover;
an ambient air cylinder/flow control valve, for seizing the anti-kickback device when a sudden pressure is applied during a kickback event, rigidly connected to said ambient air cylinder/flow control valve protective cover, and rigidly connected to said stage two compression springs;
a spiral wound torsion spring connector rod, for connecting the spiral wound torsion spring to the back of the anti-kickback/cut through device bar and providing pressure for closing same as a stage one cut is being completed;
a telescoping backstop rod, for preventing stage one of the anti-kick/cut through device from swinging further back than it was designed, rigidly connected to said bottom mold, and rigidly connected to said anti-kickback/cut through device;
a stage two hinge, for allowing stage two of the anti-kickback/cut through device to open and close, rigidly connected to said stage three hinge, rigidly connected to said forward facing spikes on anti-kickback/cut through device bar, and rigidly connected to said stage two compression springs;
a spiral wound torsion spring, for closing stage one of the anti-kickback/cut through device when it is deployed, rigidly connected to said telescoping backstop rod; and
a spiral wound torsion spring canister, for protecting the spiral wound torsion spring, rigidly connected to said spiral wound torsion spring.

46. The kct injury prevention chain saw as recited in claim 45, further comprising:
a guide bar mounting plate adjusting slot, for the guide bar plate to slide into and back and forth on for easy chain tension adjustment, rigidly connected to said guide bar mounting plate, and rigidly connected to said gearbox reservoir cover plate.

47. A kct injury prevention chain saw for a “kct injury prevention chain saw” for: reducing or eliminating kickback and cut through injuries associated with chainsaw operations, comprising:
a bar handle, for the operator to grip the handle in the same way no matter which degree of direction the saw body is turned;
a torso pad, for bracing the back of the saw against the operators torso;
a rear handle, for provision of an ergonomic grip for the operator and to keep the saw straight away forward from the operator;
an anti-kickback/cut through device, for prevention of kickback and cut through injuries;
a guide bar, for quick adjustment of the chain;
a forward section spike lock and release bar, for sliding back to unlock the rear facing spikes on the forward section of the anti-kickback/cut through device bar so they can lay down in a horizontal position, and sliding forward to lock the rear facing spikes in a vertical position, rigidly connected to said anti-kickback/cut through device;
a rear facing spikes, for gripping and releasing logs and trees setting on the anti-kickback/cut through device bar, rigidly connected to said forward section spike lock and release bar;
a trapezoidal shaped bar, for the rear facing spikes to lslide up and down on when being repositioned from vertical to horizontal, and to lock onto when in the vertical position;
a forward section top plate, for securing and protecting the internal components within the forward section of the anti-kickback/cut through bar, rigidly connected to said forward section spike lock and release bar;
a top plate screws, for securing the top plates on the center and forward section of the anti-kickback/cut through device bar, rigidly connected to said forward section top plate;
a center section top plate, for securing and protecting the internal components within the center section of the anti-kickback/cut through device bar, rigidly connected to said top plate screws, and rigidly connected to said trapezoidal shaped bar;
an intermittent duty pull type dc solenoid, for pulling the spike lock and release bars back so the rear facing spikes lay horizontal, rigidly connected to said trapezoidal shaped bar;
a spring-pin adjustment mechanism, for adjusting the rear handle horizontally, rigidly connected to said rear handle;
a pinwheel, for providing the locking mechanism for rotating the chainsaw incrementally as the pin is transferred between the holes in the pinwheel;
an incremental rotational control, for changing the angle of the saw incrementally either 45 or 90 degrees right or left while keeping the handles and grip in the same position when making angled cuts, rigidly connected to said pinwheel, and rigidly connected to said rear handle;
a center section spike lock and release bar, for sliding back and releasing the rear facing spikes on the center section of the anti-kickback/cut through device bar, so they can lay down in a horizontal position, and sliding forward to move the spikes into a vertical position and locking them in that position, rigidly connected to said trapezoidal shaped bar, and rigidly connected to said rear facing spikes;
an incremental rotational control spring-loaded pin, for locking the incremental rotational control at various angles in order to make angled cuts, rigidly connected to said incremental rotational control;
a torso pad pin spring mount, for allowing the torso pad to flex when the saw kicks back during cutting operations, rigidly connected to said torso pad;
a pushbutton spike control, for releasing the rear facing spikes on the anti-kickback/cut through bar when removing the bar from under logs or beside a standing tree when cutting a felling hinge, rigidly connected to said rear handle;
a throttle control, for controlling the engine speed, rigidly connected to said rear handle;
a gearbox cover, for provision of a protective cover for the gearbox and chain tension adjustment mechanism;
a guide bar mounting plate nuts, for attaching the guide bar to the guide bar adjustment plate;
a guide bar mounting plate, for attaching the guide bar onto, rigidly connected to said guide bar;
a guide bar mounting plate adjusting slot, for the guide bar plate to slide into and back and forth on for easy chain tension adjustment, rigidly connected to said guide bar mounting plate;
a gearbox reservoir cover-plate mounting screws, for securing the gearbox reservoir cover to the gearbox;
a mechanical gear assembly, for turning the shaft that turns the chain sprocket;
an oil environment centrifugal clutch, for transferring power from the engine when it reaches a certain rpm, and stopping power transfer from the engine when the chain binds, rigidly connected to said mechanical gear assembly;
a chain tension adjustment mechanism, for providing an easy adjustment of the chain, rigidly connected to said gearbox cover, and rigidly connected to said guide bar;
a gearbox reservoir cover plate, for sealing the gearbox and protecting the oil environment centrifugal clutch and mechanical gears, rigidly connected to said guide bar mounting plate adjusting slot;
a bottom mold, for providing a platform for mounting the incremental rotational control and the anti-kickback/cut through device bar;
a forward facing spikes on the bottom mold, for keeping items being cut from impeding operation of the anti-kickback/cut through device. and provide a pivot point to rock the saw on during cutting in order t clear debris from the chain, rigidly connected to said bottom mold;
a first stage hinge connector rods, for allowing the first stage of the anti-kickback/cut through device to pivot down and back when deployed, rigidly connected to said bottom mold, and rigidly connected to said anti-kickback/cut through device;
a stage two compression springs, for pushing the anti-kickback/cut through device bar back up into the closed position as a cut is being made when stage two is deployed;
a stage two compression spring protector sleeves, for protecting the stage two compression springs from damage and debris;
an ambient air cylinder/flow control valve protective cover, for protecting the ambient air cylinder/flow control valve from damage;
a forward facing spikes on anti-kickback/cut through device bar, for preventing items being cut from contacting the first stage hinge connector rods and damaging them or impeding the operation of same, rigidly connected to said anti-kickback/cut through device;
a stage three hinge, for allow the forward end of the anti-kickback/cut through device bar to hinge up when operators are cutting large logs on the ground;
an ambient air cylinder piston rod, for operation of the ambient air cylinder/flow control valve when stage two of the anti-kickback/cut through device is deployed, rigidly connected to said ambient air cylinder/flow control valve protective cover;
an ambient air cylinder/flow control valve, for seizing the anti-kickback device when a sudden pressure is applied during a kickback event, rigidly connected to said ambient air cylinder/flow control valve protective cover, and rigidly connected to said stage two compression springs;
a spiral wound torsion spring connector rod, for connecting the spiral wound torsion spring to the back of the anti-kickback/cut through device bar and providing pressure for closing same as a stage one cut is being completed;
a telescoping backstop rod, for preventing stage one of the anti-kick/cut through device from swinging further back than it was designed, rigidly connected to said bottom mold, and rigidly connected to said anti-kickback/cut through device;
a stage two hinge, for allowing stage two of the anti-kickback/cut through device to open and close, rigidly connected to said stage three hinge, rigidly connected to said forward facing spikes on anti-kickback/cut through device bar, and rigidly connected to said stage two compression springs;
a spiral wound torsion spring, for closing stage one of the anti-kickback/cut through device when it is deployed, rigidly connected to said telescoping backstop rod; and
a spiral wound torsion spring canister, for protecting the spiral wound torsion spring, rigidly connected to said spiral wound torsion spring.
